(19) United States
(12) Patent Application Publication
(10) Pub. No.: US 2016/0342689 A1
(43) Pub. Date: Nov. 24, 2016

(54) METHOD, DEVICE AND SYSTEM FOR LOADING RECOMMENDATION INFORMATION AND DETECTING WEB ADDRESS

(71) Applicant: BEIJING QIHOO TECHNOLOGY COMPANY LIMITED, Beijing (CN)

(72) Inventors: Xinchao TIAN, Beijing (CN); Xiaobing YANG, Beijing (CN); Minyi ZHANG, Beijing (CN)

(21) Appl. No.: 15/114,770

(22) PCT Filed: Dec. 31, 2014
(86) PCT No.: PCT/CN2014/095849

§ 371 Date: Jul. 27, 2016

(30) Foreign Application Priority Data
Jan. 27, 2014 (CN) 201410040400.5
Jan. 27, 2014 (CN) 201410041142.2

(51) Int. Cl. G06F 17/30; H04L 29/08

(52) U.S. Cl. CPC G06F 17/30864; G06F 17/3064; H04L 67/14

(57) ABSTRACT

Disclosed are a method, device and system for loading recommendation information and detecting a URL. The method for loading recommendation information comprises: initiating a loading request of a current webpage at a browser side; receiving a recommendation information loading identifier sent by a URL security assembly in a computer system where the browser is located with respect to the loading request, wherein the recommendation information loading identifier is a recommendation information loading identifier generated when the URL security assembly determines that the loading request conforms to a preset condition; according to webpage state information about the current webpage, requesting recommendation information from a recommendation server corresponding to the browser; and loading the recommendation information requested from the recommendation server in a browser window of the current webpage at the browser side. By the present invention, the efficiency for a user to acquire information they are interested in is increased.

### CROSS-REFERENCE TO RELATED APPLICATIONS

The present disclosure is a national stage of International Application No. PCT/CN2014/095849 filed Dec. 31, 2014, which is based upon and claims priority to Chinese Patent Application No. 201410040400.5 and No. 201410041142.2, both filed Jan. 27, 2014, the entire contents of all of which are incorporated herein by reference.

### FIELD OF TECHNOLOGY

The disclosure relates the field of information loading technologies, and in particular to a method for loading recommendation information, a method for detecting web address, a method for loading recommendation information of search result, a device for loading recommendation information, a device for detecting web address, a device for loading recommendation information of search result and a system for loading recommendation information.

### BACKGROUND

With the rapid development of Internet technologies, people are brought into an information society of network economy era to generate a profound impact on enterprise development and personal lives.

Browser is one of the most commonly used client programs. People are accustomed to obtaining webpage information on Internet via the browser. The browser is a program to display files in a web server or file system and allow a user to interact with the files. It is used to display texts, images and other information on the Internet or LAN. The texts or images could be hyperlink to link other web address, such that the user could rapidly and conveniently view a variety of information. Most of webpage are an HTML format, while some of them may be normally displayed only by a special browser.

In the meanwhile, the excess of information on the Internet makes it impossible to efficiently derive their desirable information therefrom such that the efficiency of use is degraded instead.

The user continuously searches for his or her interesting webpage information in a search engine via the browser. The search engine may necessarily search, compare and filter massive information to obtain relevant webpage information. Not only user operations may be more cumbersome and time-consuming, but also resources of the browser, the client and the search engine and network bandwidth may be heavily occupied. Thus, the efficiency of search may be very low, and the resources may be unnecessarily occupied and wasted.

### SUMMARY

In the view of above problems, the disclosure is proposed to provide a method for loading recommendation information, a method for detecting web address, a method for loading recommendation information of search result, a device for loading recommendation information, a device for detecting web address, a device for loading recommendation information of search result and a system for loading recommendation information.

According to one aspect of the disclosure, there is provided a method for loading recommendation information, comprising steps of:

initiating a loading request of a current webpage at a browser side;

receiving a recommendation information loading identifier sent with respect to the loading request from a web address security assembly in a computer system where the browser is located, wherein the recommendation information loading identifier is a recommendation information loading identifier generated when the web address security assembly determines that the loading request conforms to a preset condition;

in accordance with webpage state information about the current webpage, requesting recommendation information from a recommendation server corresponding to the browser; and

loading the recommendation information requested from the recommendation server in a browser window of the current webpage at the browser side.

According to another aspect of the disclosure, there is provided a method for detecting web address, comprising:

at a web address security assembly side, monitoring that a browser in a computer system where a web address security assembly is located initiates a loading request of current webpage;

determining whether the loading request conforms to a preset condition, and if yes, generating a recommendation information loading identifier;

sending the recommendation information loading identifier to the browser, wherein the browser is used to request for the recommendation information from its corresponding recommendation server in accordance with webpage state information about the current webpage and load the recommendation information requested from the recommendation server in a browser window of the current webpage at the browser side.

According to still another aspect of the disclosure, there is provided a method for loading recommendation information of search result, comprising:

initiating a loading request of a current webpage at a browser side;

determining the receipt of a recommendation information loading identifier sent with respect to the loading request from a web address security assembly in a computer system where the browser is located, wherein the recommendation information loading identifier is a recommendation information loading identifier sent to the browser when the web address security assembly determines the current webpage corresponding to the loading request to be a webpage corresponding to a search result item in a search result webpage of a previous search engine;

in accordance with the search keyword information in Refer information of current webpage and/or web address information of current webpage, requesting recommendation information from a recommendation server corresponding to the browser; and

loading the recommendation information requested from the recommendation server in a browser window of the current webpage at the browser side.

According to still yet another aspect of the disclosure, there is provided a method for detecting web address, comprising:

at a web address security assembly, monitoring that a browser in a computer system of a query assembly initiates a loading request of current webpage;

determining whether the current webpage corresponding to the loading request is a webpage corresponding to the search result item in the search result webpage of pervious search engine, and if yes, generating a recommendation information loading identifier;

sending the recommendation information loading identifier to the browser, wherein the browser is used to request recommendation information from a recommendation server corresponding to the browser in accordance with the search keyword information in the Refer information of current webpage and/or the web address information of current webpage and to load the recommendation information requested from the recommendation server in the browser window of the current webpage at the browser side.

According to still yet another aspect of the disclosure, there is provided a device for loading recommendation information, comprising:

a processor, configured to

initiate a loading request of a current webpage at a browser side;

receive a recommendation information loading identifier sent with respect to the loading request from a web address security assembly in a computer system where the browser is located, wherein the recommendation information loading identifier is a recommendation information loading identifier generated when the web address security assembly determines that the loading request conforms to the preset condition;

in accordance with webpage state information about the current webpage, request recommendation information from a recommendation server corresponding to the browser; and

load the recommendation information requested from the recommendation server in a browser window of the current webpage at the browser side.

According to still yet another aspect of the disclosure, there is provided a device for detecting web address, comprising:

a processor, configured to

monitor that a browser in a computer system where a web address security assembly is located initiates a loading request of current webpage at a web address security assembly side;

determine whether the loading request conforms to a preset condition, and if yes, invoke a recommendation information loading identifier generating module;

generate a recommendation information loading identifier; and

send the recommendation information loading identifier to the browser, wherein the browser is used to request for the recommendation information from its corresponding recommendation server in accordance with webpage state information about the current webpage and load the recommendation information requested from the recommendation server in a browser window of the current webpage at the browser side.

According to still yet another aspect of the disclosure, there is provided a device for loading recommendation information of search result, comprising:

a processor, configured to

initiate a loading request of a current webpage at a browser side;

determine the receipt of a recommendation information loading identifier sent with respect to the loading request from a web address security assembly in a computer system where the browser is located, wherein the recommendation information loading identifier is a recommendation information loading identifier sent to the browser when the web address security assembly determines the current webpage corresponding to the loading request to be a webpage corresponding to a search result item in a search result webpage of a previous search engine;

in accordance with the search keyword information in Refer information of current webpage and/or web address information of current webpage, request recommendation information from a recommendation server corresponding to the browser; and

load the recommendation information requested from the recommendation server in a browser window of the current webpage at the browser side.

According to still yet another aspect of the disclosure, there is provided a device for loading recommendation information of search result, comprising:

a processor, configured to

initiate a loading request of a current webpage at a browser side;

determine the receipt of a recommendation information loading identifier sent with respect to the loading request from a web address security assembly in a computer system where the browser is located, wherein the recommendation information loading identifier is a recommendation information loading identifier sent to the browser when the web address security assembly determines the current webpage corresponding to the loading request to be a webpage corresponding to a search result item in a search result webpage of a previous search engine;

in accordance with the search keyword information in Refer information of current webpage and/or web address information of current webpage, request recommendation information from a recommendation server corresponding to the browser; and

load the recommendation information requested from the recommendation server in a browser window of the current webpage at the browser side.

According to still yet another aspect of the disclosure, there is provided a system for loading recommendation information, comprising a browser, a web address security apparatus and a recommendation server, wherein

the browser comprises a device for loading recommendation information which comprises:

a loading request initiating module, configured to initiate a loading request of a current webpage at a browser side;

a recommendation information loading identifier receiving module, configured to receive a recommendation information loading identifier sent with respect to the loading request from a web address security assembly in a computer system where the browser is located;

a recommendation information requesting module, configured to, in accordance with webpage state information about the current webpage, request recommendation information from a recommendation server corresponding to the browser; and

a recommendation information loading module, configured to load the recommendation information requested from the recommendation server in a browser window of the current webpage at the browser side,

the web address security apparatus comprises a device for detecting web address which comprises:

a monitoring module, configured to monitor that a browser in a computer system where a web address security assembly is located initiates a loading request of current webpage at a web address security assembly side;

a determining module, configured to determine whether the loading request conforms to a preset condition, and if yes, invoke a recommendation information loading identifier generating module;

a recommendation information loading identifier generating module, configured to generate a recommendation information loading identifier; and

a recommendation information loading identifier sending module, configured to send the recommendation information loading identifier to the browser,

the recommendation server stores one or more pieces of recommendation information, and the recommendation server comprises:

a recommendation module, configured to, when receiving a request for recommendation information sent from the browser side, search for the recommendation information corresponding to the webpage state information about the current webpage.

According to still yet another aspect of the disclosure, there is provided a system for loading recommendation information, comprising a browser, a web address security apparatus and a recommendation server, wherein

the browser comprises a device for loading recommendation information of search result which comprises:

a loading request initiating module, configured to initiate a loading request of a current webpage at a browser side;

a recommendation information loading identifier receiving module, configured to determine the receipt of a recommendation information loading identifier sent with respect to the loading request from a web address security assembly in a computer system where the browser is located;

a recommendation information requesting module, configured to, in accordance with the search keyword information in Refer information of current webpage and/or web address information of current webpage, request recommendation information from a recommendation server corresponding to the browser; and

a recommendation information loading module, configured to load the recommendation information requested from the recommendation server in a browser window of the current webpage at the browser side,

the web address security apparatus comprises a device for detecting web address which comprises:

a monitoring module, configured to, at a web address security assembly, monitor that a browser in a computer system of a query assembly initiates a loading request of current webpage;

a determining module, configured to determine whether the current webpage corresponding to the loading request is a webpage corresponding to the search result item in the search result webpage of pervious search engine, if yes, invoke a recommendation information loading identifier generating module;

a recommendation information loading identifier generating module, configured to generate a loading identifier; and

a recommendation information loading identifier sending module, configured to send the recommendation information loading identifier to the browser,

the recommendation server stores one or more pieces of recommendation information, and the recommendation server comprises:

a recommendation module, configured to, when receiving a request for recommendation information sent from the browser side, search for the recommendation information corresponding to the webpage state information about the current webpage.

According to still another aspect of the disclosure, there is provided a computer program, including computer readable codes, wherein a computing device executes any one of the method for loading recommendation information, the method for detecting web address and the method for loading recommendation information of search result when the computer readable codes are operated on the computing device.

According to still yet another aspect of the disclosure, there is a computer readable medium, in which the computer program as stated above is stored.

The disclosure may have following beneficial effects:

According to the disclosure, in response to the request of loading the current webpage, it is possible to receive the recommendation information loading identifier, request for the recommendation information from the recommendation server and load it in the browser window, and load webpage behavior to obtain the recommendation information according to user's request, thereby increasing coverage of the recommendation information and satisfying with user's demand with an improved practicability. Therefore the recommendation information can more exactly reflect the user's personalized interests and hobbies, whereby pushing information to improve the matching ratio of the user's interests and hobbies with the recommendation information. The user may obtain his or her interested recommendation information without manually searching for and filtering information, thereby reducing operation steps of search, comparison and filtration for obtaining interested information and improving efficiency of obtaining user's interested information. In the meanwhile, since user's operation steps are reduced, the resource consumption of the browser and server can be reduced and accordingly the occupation of network resource can be lowered.

Upon the determination on the loading request by the preset conditions, the disclosure may not allow the loading request inconsistent with the preset conditions to request the recommendation information, while allowing the loading request consistent with the preset conditions to request the recommendation information, thereby greatly reducing the requests for the recommendation information from the recommendation server and significantly lowering the resource occupation of the recommendation server.

According to the disclosure, in response to the request of loading the current webpage, it is possible to receive the recommendation information loading identifier, request for the recommendation information on the recommendation server and load it in the browser window, and load webpage behavior to obtain the recommendation information according to user's request, thereby increasing coverage of the recommendation information and satisfying with user's demand with an improved practicability. Therefore the recommendation information can more exactly reflect the user's personalized interests and hobbies, whereby pushing news information to improve the matching ratio of the user's interests and hobbies with the recommendation information. The user may obtain his or her interested recommendation information without manually searching for and filtering information, thereby reducing operation steps of search, comparison and filtration for obtaining interested information and improving efficiency of obtaining user's interested information. In the meanwhile, since user's operation steps are reduced, the resource consumption of the browser and server can be reduced and accordingly the occupation of network resource can be lowered.

Described above is merely an overview of the inventive scheme. In order to more apparently understand the technical means of the disclosure to implement in accordance with the contents of specification, and to more readily understand above and other objectives, features and advantages of the disclosure, specific embodiments of the disclosure are provided hereinafter.

### BRIEF DESCRIPTION OF THE DRAWINGS

Through reading the detailed description of the following preferred embodiments, various other advantages and benefits will become apparent to a person having ordinary skill in the art. Accompanying drawings are included merely for the purpose of illustrating the preferred embodiments and should not be considered as limiting of the invention. Further, throughout the drawings, same elements are indicated by same reference numerals. In the drawings:

FIG. 1 schematically illustrates a flowchart of steps of a method example for loading recommendation information according to an embodiment of the disclosure;

FIG. 2 schematically illustrates a flowchart of steps of a first method example for detecting web address according to an embodiment of the disclosure;

FIG. 3 schematically illustrates a flowchart of steps of a first method example for loading recommendation information of search result according to an embodiment of the disclosure;

FIG. 4 schematically illustrates a flowchart of steps of a second method example for loading recommendation information of search result according to an embodiment of the disclosure;

FIG. 5 schematically illustrates a flowchart of steps of a second method example for detecting web address according to an embodiment of the disclosure;

FIG. 6 schematically illustrates a block diagram of a device example for detecting web address according to an embodiment of the disclosure;

FIG. 7 schematically illustrates a block diagram of a first device example for detecting web address according to an embodiment of the disclosure;

FIG. 8 schematically illustrates a block diagram of a device example for loading recommendation information of search result according to an embodiment of the disclosure;

FIG. 9 schematically illustrates a block diagram of a second device example for detecting web address according to an embodiment of the disclosure;

FIG. 10 schematically illustrates a block diagram of a system example for loading recommendation information according to an embodiment of the disclosure;

FIG. 11 schematically illustrates a block diagram of a system example for loading recommendation information according to an embodiment of the disclosure;

FIG. 12 schematically illustrates a block diagram of a computing device for executing the method according the disclosure; and

FIG. 13 schematically illustrates a memory cell which is used to store or carry program codes for realizing the methods according to the disclosure.

### DESCRIPTION OF THE EMBODIMENTS

Exemplary embodiments of the disclosure will be described in detail with reference to the accompanying figures hereinafter. Although the exemplary embodiments of the disclosure are illustrated in the accompanying figures, it should be understood that the disclosure may be embodied in many different forms and should not be construed as being limited to the embodiments set forth herein. Rather, these embodiments are provided so that this disclosure will be understood thoroughly and completely and will fully convey the scope of the disclosure to those skilled in the art.

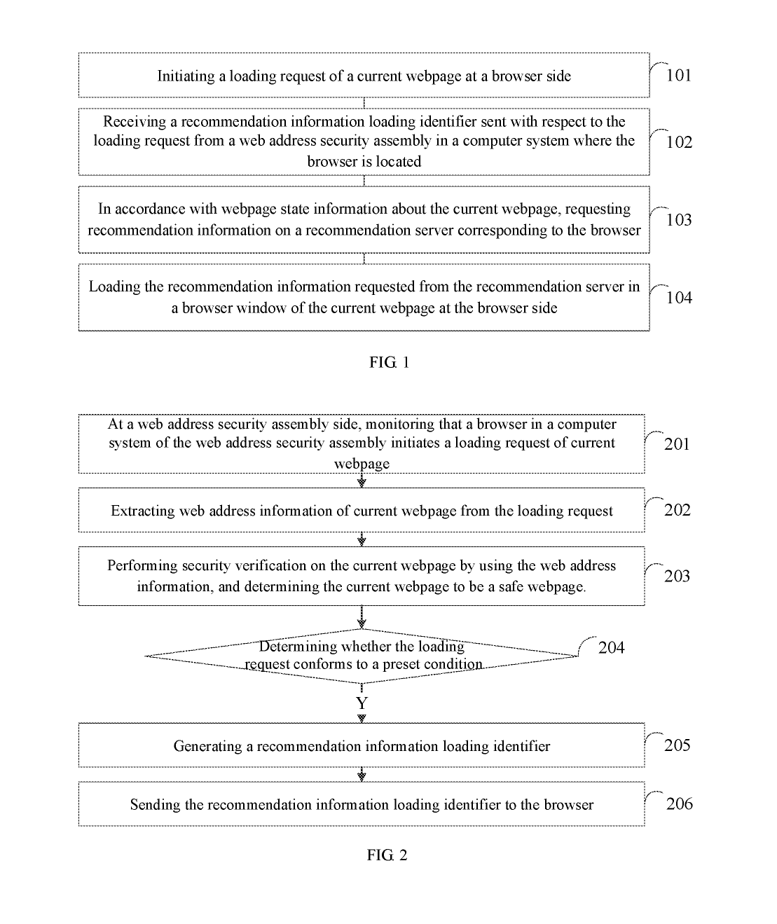

With reference to FIG. 1, it shows a flowchart of steps of a method example for loading recommendation information according to an embodiment of the disclosure. The method may particularly comprise steps of:

Step 101, initiating a loading request of a current webpage at a browser side.

The loading request of the current webpage could refer to an instruction to load a webpage sent by a user. For example, the user may open a webpage by clicking a link or by inputting web address at an address bar. When the user instructs to click a link, it is equivalent to a receipt of an instruction to load a webpage from the user; similarly, when the user inputs web address at the address bar and clicks OK button or presses the Enter key, it is also equivalent to a receipt of an instruction to load a webpage from the user.

Step 102, receiving a recommendation information loading identifier sent with respect to the loading request from a web address security assembly in a computer system where the browser is located, wherein the recommendation information loading identifier is a recommendation information loading identifier generated when the web address security assembly determines that the loading request conforms to a preset condition.

With the application of this embodiment of the disclosure, when it is monitored that the browser requests to load the webpage, the web address security assembly may determine the preset condition of the webpage which is requested to load. When determining that the loading request conforms to the preset condition, the web address security assembly generates the recommendation information loading identifier and returns it to the browser. When determining that the loading request does not conform to the preset condition, the web address security assembly may not generate the recommendation information loading identifier and the browser loads the webpage normally.

Herein, the recommendation information loading identifier could be a ground on which the browser requests for the recommendation information on a recommendation server corresponding thereto. In the presence of the recommendation information loading identifier, the browser may request for the recommendation information from the recommendation server, and accordingly the recommendation server may return corresponding recommendation information.

In practice, the preset condition may include:
the current webpage corresponding to the loading request is a webpage corresponding to a search result item in a search result webpage of search engine;
in this preset condition, the user may input search keywords on the search engine, then the search engine may inquire relevant webpage information to return one or more search result items in the search result webpage, and the user may request to open a webpage corresponding to one of search result items;
and/or,
the current webpage corresponding to the loading request is a specified webpage;
in this preset condition, the user may request to load the specified webpage, such as a shopping website, a sports website and a military website.
and/or,
the current webpage corresponding to the loading request is a verified safe webpage;
in this preset condition, the web address security assembly may perform security verification on the webpage and verify it as the safe webpage; when the current webpage is a verified dangerous webpage, the recommendation information loading identifier may not be returned.

When the browser receives the recommendation information loading identifier, it means the recommendation server can be requested to load the recommendation information.

Step 103, in accordance with webpage state information about the current webpage, requesting recommendation information from a recommendation server corresponding to the browser.

In a specific implementation, the webpage state information may include one or more types as follows:

Refer information corresponding to URL (Universal Resource Locator) of current webpage, web address information of current webpage, title information, identification information of computer hardware and extended information, wherein
the Refer information of current webpage could be information which records a URL corresponding to a search result webpage obtained by submitting search keywords in the search engine;
the web address information of current webpage could be information which records a URL of the current webpage requested to load;
the title information could be information which records a title corresponding to the current webpage requested to load;
the identification information of computer hardware could be information which identifies computer hardware where the browser is located; and
the extended information could include information which records setting parameters when other recommendation information is previously loaded.

For example, when the user inputs search keywords “mobile phone” on the search engine and opens “XX Encyclopedia” webpage in a search result webpage item, the browser may send following webpage state information to the server:
Refer information of current webpage (which could be represented by “Refer”):
http://so.***.cn/s?ie=utf-8&src=hao_search&q=%E6%89%8B%E6%9C%BA #product-title;
URL information of current webpage (which could be represented by “Url”):
http://baike.***.com/doc/5339213.html#5339213-5574654-0;
title information (which could be represented by “Title”):
Mobile Phone_XX Encyclopedia;
identification information of computer hardware (which could be represented by “mid”):
it could be hardware information about the computer where the browser is located, such as a unique identification number of hardware equipment of the browser calculated based on MAC, which is generated by algorithm and which is surely a unique value;
extended information (which could be represented by “KV”, i.e., Key-Value pair):
it could be used for extended functions of the browser.

In an optional example according to this embodiment of the disclosure, the extended information may include one or more types as follows:
an exhibition parameter, an opening parameter, a closing parameter and a recommendation information identifier, wherein
the exhibition parameter could be a parameter which records exhibited or non-exhibited recommendation information when the recommendation information is loaded;
the opening parameter could be a parameter which records manual opening or automatic opening of loading the recommendation information;
the closing parameter could be a parameter which records manually closed or unclosed recommendation information when the recommendation information is loaded; and
the recommendation information identifier could be a session established between the browser and the recommendation server when the identifier loads the recommendation information.

For example, the extended information (which could be represented by “KV”, i.e., Key-Value pair) may include:
the exhibition parameter (which could be represented by “Show”):
“0” may represent “non-exhibited”, and “1” may represent “exhibited”;
the opening parameter (which could be represented by “Open”):
“1” may represent that the recommendation information is automatically opened, and “2” may represent that the recommendation information is manually opened;
the closing parameter (which could be represented by “Close”):
“1” may represent that the recommendation information is manually closed;
the recommendation information identifier (which could be represented by “Sid”):
it is a unique ID of the recommendation information, which could be assigned by the recommendation server, such as 1001.

In practice, by the extended information, the browser may send the information which records setting parameters when previously loading other recommendation information to the recommendation server; the recommendation server may be used to make statistics on user behavior information by the extended information, and in accordance with the user behavior information, return corresponding recommendation information to the browser side requesting for the recommendation information. For example, in the case that a certain kind of recommendation information is frequently manually closed by the user, the recommendation server may exclude this kind of recommendation information from the preset condition and no longer recommend it.

In this embodiment of the disclosure, by the user behavior information, the information which is suitable to be recommended and which is not suitable to be recommended can be determined, thus following user's behavior habits, satisfying user's demands and increasing the use efficiency of the recommendation server, the browser and the bandwidth. In a preferred embodiment of the disclosure, Step 103 may comprise sub-steps of:

Sub-Step S11, when the current webpage is a specified webpage, using the webpage state information at least including the web address information of the current webpage to request the recommendation information from the recommendation server corresponding to the browser, wherein the server is used to search for the recommendation information corresponding to the web address information of the current webpage in accordance with the request.

At Sub-Step S11, the recommendation server may obtain a parent webpage layer by layer in accordance with the current webpage URL, then extract a tag of each layer of webpage, extract keywords, and in the end search for the corresponding recommendation information in accordance with the keywords.

For example, the current webpage URL is http://www.***.com/flash/72550.htm, with a webpage tag of the Three Kingdoms Town, which is a kind of flash game; its parent webpage is http://www.***.com/special/1.htm, with a webpage tag of two-player mini-game of the all; its parent webpage of the parent webpage is http://www.***.com/, which is the homepage of website, with a tag of web game platform. The keywords for extraction would be Flash mini-game, and the recommendation information corresponding to the flash mini-game is searched for. For example, top N of the most popular flash mini-games in current network are searched for, wherein N is a positive integer.

and/or,

Sub-Step S12, when the current webpage is loaded, using the webpage state information at least including the title information to request the recommendation information from the recommendation server corresponding to the browser, wherein the server is used to search for the recommendation information corresponding to the title information in accordance with the request.

At Sub-Step S12, the browser may search HTML (Hyper Text Markup Language) documents for a title tag <title>. The <title> may advise the user of a subject matter of an article. The browser may extract a title of a webpage article for the <title> and send it to the recommendation server. The recommendation server may search for the recommendation information corresponding thereto.

and/or,

Sub-Step S13, when the current webpage is the search result webpage of the search engine, using the webpage state information at least including the Refer information of the current webpage to request the recommendation information from the recommendation server corresponding to the browser, wherein the server is used to perform a URL structure analysis by the Refer information of the current webpage in accordance with the request, to extract search keyword information from the URL of the current webpage, to decode the search keyword information in accordance with a predefined webpage encoding rule to obtain the search keywords, and to search for the recommendation information corresponding to the search keywords.

In a specific implementation, a plenty of search engines are based upon a GET request mode. In other words, the URL is followed by a string of different parameters, and depending on the search engines, identifications of their search keyword information may be different. For example, the identifications of search keyword information could be “wd=”, “q=”, “hl=” and etc.

For example, in a URL of a search result webpage obtained by searching for a search keyword:
URL of a search result webpage of a search engine A could be:
http://www.AAA.cn/search?sourceid=navclient&hl=zh-CN&ie=UTF-8&rlz=1 T4GGLL_zh-CN_CN352&q=%e7%a7%8b%e5%af%92%e5%8d%9a%e5%ae%a2
URL of a search result webpage of a search engine B could be:
http://www.BBB.com/s?wd=%C7%EF%BA%AE%B2%A9%BF%CD
URL of a search result webpage of a search engine C could be:
http://cn.bing.com/search?q=%E7%A7%8B%E5%AF%92%E5%8D%9A%E5% AE%A2&form=QBLH&filt=all

“q=%e7%a7%8b %e5%af%92%e5%8d %9a %e5%ae%a2” in the search result webpage URL of search engine A, “wd=%C7%EF%BA%AE%B2%A9%BF%CD” in the search result webpage URL of search engine B and “q=%E7%A7%8B%E5%AF%92%E5%8D%9A%E5%AE%A2” in the search result webpage URL of search engine C are search keywords. Other search engines are substantially the same. Fields of keywords could be known from the URL, and then search keywords could be extracted by regular expressions.

In other words, the recommendation server may abstract the regular expressions of the search keywords in advance, by which the search keyword information in the current webpage URL can be extracted.

Examples of the regular expressions of the search keywords are as follows:
(?:yahoo.+?[\?|&]p=|openfind.+?query=|google.+?q=|lycos.+?query=|onseek.+?keyword=|search\.tom.+?word=|search.\qq\.com.+?word=|zhongsou\.com.+?word=|search\.msn\.com.+?q=|yisou\.com.+?p=|sina.+?word=|sina.+?query=|sina.+?_searchkey=|sohu.+?word=|sohu.+?key_word=|sohu.+?query=|163.+?q=|baidu.+?wd=|baidu.+?kw=|baidu.+?word=|3721\com.+?p=|Alltheweb.+?q=|soso.+?w=|115.+?q=|youdao.+?q=|sogou.+?query=|bing.+?q=|114.+?kw=)([̂&]*)

In practice, after different webpage encoding rules (charset) are used to encode the same character, codes are differently generated. That is, the search keyword information in the aforesaid search result webpage URL of search engines A, B and C is different.

For example, the webpage encoding rule could be include UTF-8, GB2312 and etc.

UTF-8 normally generates default UTF-8 encoding, and accordingly default decoding is UTF-8. The webpage encoding rule of GB2312 is similar thereto.

For the decoding of UTF-8 and GB2312, the search engine can be used to determine the webpage encoding rule. Then it is necessary to search and collect in advance the webpage encoding rule to which each search engine is applied.

In addition, in the search keyword information, %xx%xx format is URL encoding (UTF-8 or GB2312); in GB2312 a Chinese character is constituted of two groups of %xx, and in UTF-8 the Chinese character is constituted of three groups of %xx; if UTF-8 decoding mode is used to decode GB2312 codes, messy codes may occur.

Since UTF-8 is constituted of three groups of %xx and GB2312 is constituted of two groups of %xx, if UTF-8 decoding mode is used to decode GB2312 and successfully decode, then a length of decoded character is bound to be shortened. For example, four Chinese characters by the GB2312 URL encoding are “%C7%EF%BA%AE%B2%A9%BF%CD”. When using UTF-8 encoding mode to decode, if successful, the length of decoded characters may be two and half Chinese characters. If failed, it means that the webpage encoding rule is GB2312 encoding mode.

Therefore, the recommendation server may employ following steps to identify the webpage encoding rule of URL:

1. obtaining search keyword information, wherein it is necessary to translate non-Chinese URL to remove English;

2. getting the number (x) of groups of the search keyword information; for example, the search keyword information “q=%C7%EF%BA%AE%B2%A9%BF%CD” is divided into 8 groups;

3. using UTF-8 decoding mode to decode the obtained encoding string;

4. if the decoding is failed (for example, program failure), then going to Step 8;

5. if successfully decoded, obtaining a length (y) of decoded character string and comparing with a number dividing the group number of overall search keyword information by 3;

6. if x!=y, then going to Step No. 8;

7. if x=y, then using the obtained character string as the search keywords; and

8. decoding with GB2312 mode and using the obtained character string as the search keywords.

It should be explained that, any one or more of Sub-Step S11, Sub-Step S12 and Sub-Step S13 can be applied to this embodiment of the disclosure, which is not limited thereby. For example, before loading current webpage, the URL information of current webpage can be sent to the recommendation server; and after loading current webpage, the title information can be continuously sent to the recommendation server. As another example, the URL information of current webpage and the Refer information of current webpage can be sent to the recommendation server.

In practice, upon the receipt of the recommendation information request sent at the browser side, the recommendation server may search for the recommendation information corresponding to the webpage state information about the current webpage.

In order to increase user viscosity, most of platforms may push a variety of information. In other words, push servers for recommendation information have already been disposed.

However, in this embodiment of the disclosure, the recommendation server could be a individually disposed server; or, individual transfer servers can be disposed and then existing push servers are multiplexed. Therefore, one machine may have multiple functions without individually disposing a set of new recommendation servers, thereby greatly reducing the cost.

In particular, the transfer server can receive the webpage state information sent from the browser, make statistics on the user behavior information, and then send http to the push server to request for NLP (Natural Language Processing) service. The information interaction can be achieved between the transfer server and the push server by a predefined format (for example, proto). The transfer server may decode the recommendation information request and add the information which is not submitted by the browser but necessary for the push server (for example, request IP) to the request for the use of the push server. The push server may search for the recommendation information by using NLP technique, and then the transfer server may return it to the browser.

For example, information of the predefined format proto could include one or more kind of operation information (message StringPair), URL information (message URL), message request body (message ReqBody), message response body (message RespBody), request message (message Request) and response message (message Response), wherein
the operation information (message StringPair) may record required key bytes and optional byte value, such as

```
message StringPair {
    required bytes key = 1;
    optional bytes value = 2;
}
```

The URL information (message URL) may record information about webpage URL sent from the browser, such as byte character (charset), webpage type (type), URL itself (url), webpage server identification (host), hyperlink path (uniurl), webpage title (title). A specific example is as follows:

```
message URL {
    enum Type {
        kT_Unknown = 0;
        kT_Full = 1;
        kT_Intercept = 2; //truncated url
    }
    enum Charset {
        kCS_Unknown  = 0;
        kCS_UTF8  =1;
        kCS_GBK = 2;
        kCS_BIG5 = 3;
    }
    required Charset charset = 1 [default = kCS_Unknown];
    required Type type = 2 [default = kT_Unknown ];
    optional bytes url = 3; // visited url
    optional bytes host = 4;
    optional bytes uniurl = 5; // uniformed url
    optional bytes title = 6; // url-page's title
}
```

The message request body (message ReqBody) may include request message identification (for example, ID), URL type of current webpage (page_url) and Refer information type of current webpage (page_refers), for example. A specific example is as follows:

```
            message ReqBody{
                required int32 id = 1 [default = 0]; // IDs in
the same request need to have the same number from 0
                required int32 ver = 2 [default = 0];
                optional URL page_url = 3; // URL
class, the corresponding title belongs to a URL entity for the convenience
of processing logic of amendments such as url normalization
                repeated URL page_refers = 4;
            }
```

The message response body (message RespBody) may include response message identification (for example, ID), recommendation information identifier (sid) and display data of exhibition window, for example. A specific example is as follows:

```
            message RespBody{
                required int32 id = 1 [default = 0 ]; // correspond
                to ReqBody.id
                required int32 ver = 2 [default = 0 ]; // correspond
                to ReqBody.ver
                required bytes sid = 3 [default = “”]; // server-
                generated session id
//session id generated by transfer server is sent to the browser and
used as a unique ascertained id for the browser to make statistics
and report
                optional bytes html = 4;
                optional bytes tple = 5;
                optional bytes data = 6;
                repeated StringPair ctrl = 7; //used
as control information except for practical content, such as height
            }
```

The request message (message Request) may include request type (ReqType type), product (product), subtype of product (combo), browser version (browser_ver), user identification (mid) and extended information (0), for example. A specific example is as follows:

```
            message Request{
                enum ReqType{
                    RecommendTip = 0; // default
                }
                required ReqType type = 1 [default = RecommendTip]; //
default request type is current functions to avoid adding function discrimination to a popup
box under a subsequent browser
                required string product = 2 [default = “”]; //product
                required string combo = 3 [default = “”]; // subtype of
product
                required string browser_ver = 4 [default = “”];
                required string mid = 5 [default = “”]; //user ID
                repeated StringPair head = 6; // all stat info //all extended
information and satellite information of other requests are stored herein, such as open: 1,
disable: 0, pop: sid, click=1, clientip=111.111.111.111, for example
                repeated ReqBody body = 7;
            }
```

The response message (message Response) may include head information (head) and body information (body). A specific example is as follows:

```
message Response{
    repeated StringPair head= 1;
    repeated RespBody body= 2;
}
```

Step 104, loading the recommendation information requested from the recommendation server in a browser window of the current webpage at the browser side.

In a specific implementation, the recommendation information may include item data and display attribute data, wherein the item data could be HMTL documents in conformity with a browser definition standard, as substantial contents of the recommendation information; and the display attribute data could be parameter data set for loading an exhibition window of the item data by the recommendation server in accordance with the current browser and the item data.

In a preferred embodiment of the disclosure, Step 104 may comprise sub-steps of:

Sub-Step S21, generating an exhibition window in the browser window of the current webpage at the browser side in accordance with the display attribute data.

In a specific implementation, the display attribute data may be represented by the form of a Key-Value pair. The display attribute data may include a position, height and width of the exhibition window, a position of the item data in the exhibition window, and positions of function keys of the exhibition window in the exhibition window, for example.

For example, the display data may include height:97, which means that the display window has a height of 97px (pixel). In practice, the exhibition window may be generated below the current webpage with a height of 97px and a width in consistent with a main window of the browser; a partition line with a height of 3px is provided on the display window; and the left side of the item data has a 20px distance from a frame of the browser, for example.

Herein, the function keys of exhibition window could include a closing key and a settings key. In a life cycle of the recommendation information, when the user clicks on the closing key, the exhibition window may shut up accordingly and will not display any more. With the settings key, the user may selectively set the exhibition window to be automatically open or manually open.

Sub-Step S22, receiving the item data sent from the recommendation server.

In a preferred example of the embodiment of the disclosure, the browser side may have a recommendation information identifier corresponding to current recommendation information established at the recommendation server side.

In this example, Step S22 may further comprise sub-steps of:

Sub-Step S221, receiving the item data sent from the recommendation server with respect to the exhibition window and the recommendation information identifier corresponding to the current recommendation information.

The recommendation information identifier (sid) could be an identification number of session established between the recommendation server and the browser. In other words, a unique session identifier is provided between the display window in each browser and the recommendation server, such that the recommendation server can easily transfer the recommendation information with a specified display window in its session.

Sub-Step S23, displaying the item data in the exhibition window.

In a specific implementation, the loading can be performed in accordance with a preset position of the item data by the display attribute data.

It should be explained that, before the HTML texts of the current webpage are completely loaded, the exhibition window can be set to a hidden attribute which includes function keys in non-clickable state. After the HTML texts of the current webpage are completely loaded, when a mouse wheel rolling event within the current webpage is monitored and the recommendation information is set to be “actively start”, then the exhibition window may be popped up directly to display the item data.

The exhibition window may vary according to the width of main window of the browser with the height thereof unchanged. The item data can be self-adapted gradually according to the width of browser. For example, the item data is increased according to the increment in the width; and the item data is reduced according to the reduction in the width.

In a preferred example of the embodiment of the disclosure, the item data could include one or more of following items:
text information, image information, audio information, video information and Flash information.

In particular, the item data could include one or more items. For example, on a left side of the exhibition window, the text information such as “Sun” and “Moon” corresponds to the image information, and on a right side of the exhibition window, “Halley's Comet” and “Titan” only correspond to text information.

Of course, the aforesaid item data is only exemplary. In the implementation of the embodiment of the disclosure, it is possible to set other item data according to the practical situation, which is not restricted by the embodiment of the disclosure.

In the application of the embodiment of the disclosure, each webpage window at the browser side may store the corresponding recommendation information. The browser may be formed of Tab webpage windows. If a webpage loaded in each Tab webpage window conforms to the preset condition, then the recommendation information corresponding to the current webpage may be loaded.

In a preferred embodiment of the disclosure, the method may further comprises steps of:

Step 105, when the recommendation information is triggered, initiating a search request on the search engine by the recommendation information.

In a specific implementation, a trigger point is embedded in the item data. When the user selects an item of the item data by a mouse click or a special function key, then the text information corresponding to the item data may be used to initiate the search request on the search engine.

Step 106, loading a search result obtained by using the recommendation information to search in accordance with the search request through the search engine.

In a specific implementation, the browser may newly open a webpage window, and the search result returned by the search engine may be loaded.

In this embodiment of the disclosure, each URL corresponding to the search result webpage initiated by the recommendation information may have a uniform src identifier to identify that the search is initiated by the recommendation information. The search engine may make statistics on the corresponding user behavior information such as UV (unique visitor, which refers to different natural persons browsing this webpage by accessing the Internet) and PV (Page View, which refers to page views or click rates wherein one is recorded every time a user visits each webpage in a website) and then send it to the recommendation server. The recommendation server may return corresponding recommendation information to the browser side where the recommendation information is requested in accordance with the user behavior information. For example, a URL of a search result webpage initiated by the recommendation information could be as follows:
http://www.***.com/s src=se_related&q=%E8%81%94%E9%80%9A%E4%B8%8A%E8%B0%83%E9%87%91%E9%93%B6iPhone%205s%E5%90%88%E7%BA%A6%E4%BB%B7
wherein, “src=se_related” is the src identifier.

According to the disclosure, in response to the request of loading the current webpage, the method may receive the recommendation information loading identifier, request for the recommendation information on the recommendation server and load it in the browser window, and load webpage behavior to obtain the recommendation information according to user's request, thereby increasing coverage of the recommendation information and satisfying with user's demand with an improved practicability. Therefore the recommendation information can more exactly reflect the user's personalized interests and hobbies, whereby pushing news information to improve the matching ratio of the user's interests and hobbies with the recommendation information. The user may obtain his or her interested recommendation information without manually searching for and filtering information, thereby reducing operation steps of search, comparison and filtration for obtaining interested information and improving efficiency of obtaining user's interested information. In the meanwhile, since user's operation steps are reduced, the resource consumption of the browser and server can be reduced and accordingly the occupation of network resource can be lowered.

With reference to FIG. 2, it shows a flowchart of steps of a first method example for detecting web address according to an embodiment of the disclosure. The method may particularly comprise steps of:

Step 201, at a web address security assembly side, monitoring that a browser in a computer system where a web address security assembly is located initiates a loading request of current webpage.

Step 202, extracting web address information of current webpage from the loading request.

In a specific implementation, the web address security assembly may monitor a webpage loading request by a specified response event interface. For example, when, by the specified response event interface achieving a standard plug-in mechanism, a URL of webpage corresponding to the web address requested to visit by the browser is obtained, it is indicated that the loading request of current webpage initiated by the browser is monitored. For example, in a Trident kernel browser, such as an IE (Internet Explorer) browser, a Browser Helper Object (BHO) plug-in mechanism can be used, and by responding to a “BeforeNavigate2” event, a webpage web address currently being loaded by the browser can be obtained. In a Webkit kernel browser, such as a Chrome browser, a Netscape Plug-in Application Programming Interface (NPAPI) plug-in mechanism can be used to obtain a web address currently being loaded by the browser.

Or, in response to a request of loading webpage, the browser may first send the request of loading webpage to the web address security assembly.

Step 203, performing security verification on the current webpage by using the web address information, and determining the current webpage to be a safe webpage.

In this embodiment of the disclosure, the current webpage corresponding to the loading request is a verified safe webpage.

In practice, the web address security assembly may first perform a normalized processing on the current webpage URL. For example, uppercase and lowercase letters in web address (including information, such as protocol, host name, path name, file name and parameter) are unified, and redundant path symbols and parameters in the URL are removed.

For example, the current webpage URL is: HTTp://www.A.com//aBc/abc.Php?A=1;

The uppercase and lowercase letters therein are unified to be lowercase letters: http://www.a.com//abc/abc.php?a=:1;

The redundant path symbols are removed as follows: http://www.a.com/abc/abc.php?a=1;

Then, the web address security assembly may extract web address cipher text corresponding to the current webpage URL. For the web address, three types of key information are URL itself (url), host name of web address (host) and first domain name section of web address (domain name).

In particular, the host name could be a host part with the removal of information such as path symbol, protocol head and port number in the URL, and the first domain name section could be traced back level by level from right to left according to the host name of URL. Optionally, when obtaining the first domain name section, a maximum 7 levels can be traced back from right to left.

If a right-to-left first level root domain name of the host name of the current webpage URL is an international top-level domain name, then the first domain name section of the current webpage URL is a first level sub-domain name of the host name of the current webpage URL. Herein, the international top-level domain name may refer to common top-level domain name such as “com”, “net”, “org”, “edu” and “gov”. For example, the host name of the current webpage URL is www.a.com, the first level root domain name is “com”, and then its first level sub-domain name “a.com” may be extracted to be the first domain name section of the current webpage URL.

If the right-to-left first level root domain name of the host name of the current webpage URL is a country code top-level domain name and the first level sub-domain name includes international top-level domain name, then the first domain name section of the current webpage URL is a second level sub-domain name of the host name of the current webpage URL. Herein, the country code top-level domain name may refer to special top-level domain name such as “cn” and “hk”. For example, the host name of the current webpage URL is www.a.com.cn, its right-to-left first level root domain name is “cn”, the first level sub-domain name is “com.cn”, and then its second level sub-domain name “a.com.cn” may be extracted to be the first domain name section of the current webpage URL.

If the host name of the current webpage URL uses a dynamic domain name, then the first domain name section of the current webpage URL is a next level sub-domain name of the host name of the current webpage URL extracted from the dynamic domain name towards right hand. Herein, the dynamic domain name refers to some second or third level dynamic domain names, such as “3322.org”, “s.3322.org” and “s.3322.nct” dynamic domain name. For example, the host name of the current webpage URL is www.a.3322.org wherein a dynamic domain name “3322.org” is used, then next level sub-domain name “a.3322.org” is extracted from the dynamic domain name towards right hand to be the first domain name section of the current webpage URL.

In this embodiment of the disclosure, after the current webpage URL is obtained, feature values of any one or more of the three types of information, such as host name of URL and the first domain name section, can be extracted to be the cipher text. Optionally, the feature value could be a Hash value. Particularly, the feature value could be a Hash value calculated on the basis of Message Digest Algorithm fifth edition, (md5), or a feature code capable of uniquely identifying original information (url, host, domain name) such as SIIA1 code or CRC (Cyclic Redundancy Check) code. In following examples, description will be given by way of 32-bit md5 Hash value.

For example, the current webpage URL is: http://www.a.com/abc/abc.php?a=1; according to above method, the obtained host name of the current webpage URL is: www.a.com; and the obtained first domain name section of the current webpage URL is: a.com.

Calculated 32-bit md5 Hash value of the current webpage URL itself is:
md5(http://www.a.com/abc/abc.php?a=1,32)=e2a6b69ffl5c6a8c276f089250a b3f7d

Calculated 32-bit md5 Hash value of the host name of the current webpage URL is:
md5 (www.a.com,32)=30f4a7bbefe70d75616707c80921a7c8

Calculated 32-bit md5 Hash value of the first domain name section of the current webpage URL is:
md5 (a.com,32)=b3655bd7aad56513fcdacbd4254ed6b7

The above calculated 32-bit md5 Hash value of the current webpage URL, the 32-bit md5 Hash value of the host name of the current webpage URL and the 32-bit md5 Hash value of the first domain name section of the current webpage URL are the web address cipher texts of the current webpage URL.

In above example where the current webpage URL is: http://www.a.com/abc/abc.php?a=1, an obtained set of web address cipher texts of the current webpage URL could be as follows:
domain name |host|url
a.com|www.a.com|http://www.a.com/abc/abc.php?a=1
b3655bd7aad56513fcdacbd4254ed6b7|30f4a7bbefe70d75616707c80921a7c8 e2a6b69ffl5c6a8e276f089250ab3f7d

Next, the web address security assembly may use the web address cipher text corresponding to the current webpage URL to match in a cipher text database. If the web address cipher text corresponding to the current webpage URL matches with a cipher text which is stored in the cipher text database and which is marked as a malicious web address, then the current webpage could be determined to be a dangerous webpage; if the web address cipher text corresponding to the current webpage URL matches with a cipher text which is stored in the cipher text database and which is marked as a safe web address, then the current webpage could be determined to be a safe webpage.

It should be explained that the cipher text database stores cipher texts marked as malicious web address and/or safe web address in advance. These cipher texts may be obtained from a great number of known URLs of malicious web address and/or safe web address. Optionally, data key values in the cipher text database may be stored in accordance with feature values of three types of key information (web address url, the web address host and the web address domain name). The key values of the three types of key information may be marked on the basis of safe web address and malicious web address, respectively. In particular, the cipher text marked as malicious web address may include one or more types of following information: a feature value of malicious URL, a feature value of the host name of malicious URL and a feature value of the first domain name section of malicious URL. The cipher text marked as safe web address may include one or more types of following information: a feature value of safe URL, a feature value of the host name of safe URL and a feature value of the first domain name section of safe URL.

The cipher text database may be locally stored in the web address security assembly or in a specified cipher text server.

With the application of this embodiment of the disclosure, the cipher text server may send information in the cipher text database to the web address security assembly to update the local cipher text database at preset time (for example, 6:00 am every morning and 12:00 am every Saturday).

It should be explained that the embodiment of the disclosure may apply any one or more of the three preset conditions. For example, the current webpage is a webpage corresponding to a search result item in a search result webpage of a search engine and a safe webpage. As another example, the current webpage is specified webpage and a safe webpage. These are not restricted by the embodiment of the disclosure.

Step 204, determining whether the loading request conforms to a preset condition, and if yes, proceeding to Step 205;

In practice, the preset condition may include:
the current webpage corresponding to the loading request is a webpage corresponding to a search result item in a search result webpage of search engine;
in practice, the web address security assembly may perform a structural analysis on the current webpage URL, extract search keyword information in the URL, and decode the search keyword information in accordance with a predefined webpage encoding rule; and when successfully decoded, the current webpage may be determined to be a webpage corresponding to the search result item in the search result webpage of search engine;
and/or,
the current webpage corresponding to the loading request is a specified webpage;
in practice, it may be possible to collect specified webpage URLs in advance, then generate a specified webpage URL list and store it in a designated location, and the web address security assembly may use the current webpage URL list to match with it; when successfully matched, this means that the current webpage corresponding to the loading request is a specified webpage.

Of course, the aforesaid preset conditions are only exemplary. In the implementation of the embodiment of the disclosure, it is possible to set other preset conditions according to the practical situation, which is not restricted by the embodiment of the disclosure. Further, in addition to the aforesaid preset conditions, a person skilled in the art may employ other preset conditions according to the practical demands, which is not restricted by the embodiment of the disclosure.

Step 205, generating a recommendation information loading identifier.

For example, information generated by the web address security assembly with respect to the loading request of current webpage may include:
{v:0}{ot:1369125047}{st:20}{ch:0}{wd.info:c2M9MTAw}{trust.info:e2Q6 MzYwLmNufXt6OjZ9e3Q6MTAwNH17bTo4NWUwNjgOMzBjODcyM2VkYTczYjdhYjYz MTFiYTU2YX17bjozNjDlrpjnvZF9e2k6MX17YzoyfQ==}{child.info:bGV2ZWw9d2hpdG U=}{icp.info:e2Q6MzYwLmNufXt0OjEwMDR9e3Y6MS4wfXtwOip9}{xf.info:MAkxMzY 5MTI5ODc1CTEwMg==}{yx.info:e2g6MzYwLmNufXtjOjQwNDZ9e2U6MTcxfXtnczo4O H17czE6Mzc3NH17czI6MTc3fXtzMzoONDd9e2kxOjc2N317aTI65a6J5YWoXzczNDB8fO awuOi/nOaUr+aMgTM2MF82OTA3fHz1hY3otLlfNjE2NXx85p2A5q+SXzQ1MDZ9}{tip.info:cmVxPTE=}

Herein, tip.info is an information field returned upon the determination of the preset conditions by the loading request of current webpage to which the web address security assembly is directed. If req=1, then it is a recommendation information loading identifier, indicating there is an allowance for requesting the recommendation information on the recommendation server; if req=0, then it indicates there is no allowance for requesting the recommendation information from the recommendation server. Of course, in the embodiment of the disclosure, the situations wherein req=2 and req=3 may be included. For example, existing data is used to determine that the loading of a webpage allows to request the recommendation information from the recommendation server. However, in a situation that the current network is unstable or the webpage is attacked, then the web address security assembly may temporarily configure the loading request of the webpage to be req=2 without modifying existing data, indicating there is no allowance for requesting the recommendation information from recommendation server. After the special situation is eliminated, the loading request of the webpage may be determined according to the existing data.

Upon the determination on the loading request by the preset conditions, the disclosure may not allow the loading request inconsistent with the preset conditions to request the recommendation information, while allowing the loading request consistent with the preset conditions to request the recommendation information, thereby greatly reducing the requests for the recommendation information from the recommendation server and significantly lowering the resource occupation of the recommendation server.

Step 206, sending the recommendation information loading identifier to the browser, wherein the browser is used to request for the recommendation information from its corresponding recommendation server in accordance with webpage state information about the current webpage and load the recommendation information requested from the recommendation server in a browser window of the current webpage at the browser side.

The web address security assembly may send the generated information at least including the recommendation information loading identifier to the browser, and the browser may carry on decoding in accordance with the predefined rule and then perform subsequent loading operation based on a decoded instruction.

It should be explained that, since the embodiment of the method for detecting web address may correspond to the embodiment of the method for loading recommendation information, the description thereof is relatively simple. For the relevant part, reference can be made to the embodiment of the method for loading recommendation information. The detailed description thereof will be omitted herein

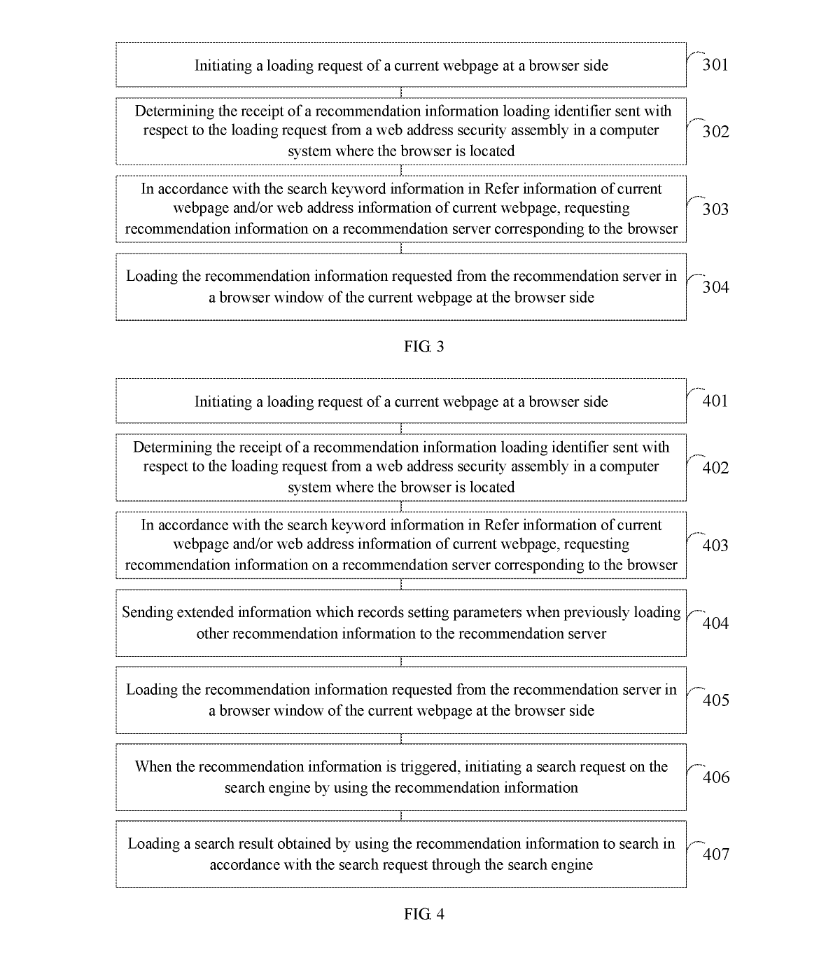

With reference to FIG. 3, it shows a flowchart of steps of a first method example for loading recommendation information of search result according to an embodiment of the disclosure. The method may particularly comprise steps of:

Step 301, initiating a loading request of a current webpage at a browser side.

The loading request of the current webpage could refer to an instruction to load a webpage sent by a user. For example, the user may open a webpage by clicking a link or by inputting web address at an address bar. When the user instructs to click a link, it is equivalent to a receipt of an instruction to load a webpage from the user; similarly, when the user inputs web address at the address bar and clicks OK button or presses the Enter key, it is also equivalent to a receipt of an instruction to load a webpage from the user.

Step 302, determining the receipt of a recommendation information loading identifier sent with respect to the loading request from a web address security assembly in a computer system where the browser is located, wherein the recommendation information loading identifier is a recommendation information loading identifier sent to the browser when the web address security assembly determines the current webpage corresponding to the loading request to be a webpage corresponding to a search result item in a search result webpage of a previous search engine.

With the application of this embodiment of the disclosure, when it is monitored that the browser requests to load the webpage, the web address security assembly may determine the preset condition of the webpage which is requested to load. When determining that the loading request conforms to the preset condition, the web address security assembly generates the recommendation information loading identifier and returns it to the browser. When determining that the loading request does not conform to the preset condition, the web address security assembly may not generate the recommendation information loading identifier and the browser loads the webpage normally.

Herein, the recommendation information loading identifier could be a ground on which the browser requests for the recommendation information from a recommendation server corresponding thereto. In the presence of the recommendation information loading identifier, the browser may request for the recommendation information from the recommendation server, and accordingly the recommendation server may return corresponding recommendation information.

In practice, the preset condition may include:
the current webpage corresponding to the loading request is a webpage corresponding to a search result item in a search result webpage of previous search engine;
in this preset condition, the user may input search keywords on the search engine, then the search engine may inquire relevant webpage information to return one or more search result items in the search result webpage, and the user may request to open a webpage corresponding to one of search result items.

In practice, the loading request may include a current webpage URL (Universal Resource Locator). The web address security assembly may be used to perform a structural analysis on the current webpage URL, extract search keyword information in the URL, and decode the search keyword information in accordance with a predefined webpage encoding rule; and when successfully decoded, the current webpage may be determined to be a webpage corresponding to the search result item in the search result webpage of search engine.

In a specific implementation, a plenty of search engines are based upon a GET request mode. In other words, the URL is followed by a string of different parameters, and depending on the search engines, identifications of their search keyword information may be different. For example, the identifications of search keyword information could be “wd=”, “q=”, “hl=” and etc.

For example, in a URL of a search result webpage obtained by searching for a search keyword:
URL of a search result webpage of a search engine A could be:
http://www.AAA.cn/search?sourceid=navclient&hl=zh-CN&ie=UTF-8&rlz=1 T4GGLL_zh-CN_CN352&q=%e7%a7%8b %e5%af%92%e5%8d %9a %e5%ae%a2
URL of a search result webpage of a search engine B could be:
http://www.BBB.com/s?wd=%C7%EF%BA%AE%B2%A9%BF%CD
URL of a search result webpage of a search engine C could be:
http://cn.bing.com/search?q=%E7%A7%8B%E5%AF%92%E5%8D%9A%E5% AE%A2&form=QBLH&filt=all
“q=%e7%a7%8b %e5%af%92%e5%8d %9a %e5%ae%a2” in the search result webpage URL of search engine A, “wd=%C7%EF%BA%AE%B2%A9%BF%CD” in the search result webpage URL of search engine B and “q=%E7%A7%8B%E5%AF%92%E5%8D%9A%E5%AE%A2” in the search result webpage URL of search engine C are search keywords. Other search engines are substantially the same. Fields of keywords could be known from the URL, and then search keywords could be extracted by regular expressions.

In other words, the recommendation server may abstract the regular expressions of the search keywords in advance, by which the search keyword information in the current webpage URL can be extracted.

Examples of the regular expressions of the search keywords are as follows:
(?:yahoo.+?[\?|&]p==|openfind.+?query==|google.+?q==|lycos.+?query==|onseek.+?keyword==|search\.tom.+?word==|search\.qq\.com.+?word==|zhongsou\com.+?word==|search\msn\.com.+?q==|yisou\.com.+?p==|sina.+?word==|sina.+?query==|sina.+?searchkey==|sohu.+?word=|sohu.+?key_word==|sohu.+?query=|163.+?q==|baidu.+?wd==|baidu.+?kw==|baidu.+?word=|3721\com.+?p==|Alltheweb.+?q==|soso.+?w=|115.+?q==|youdao.+?q==|sogou.+?query==|bing.+?q=|114.+?kw=)([̂&]*)

In practice, after different webpage encoding rules (charset) are used to encode the same character, codes are differently generated. That is, the search keyword information in the aforesaid search result webpage URL of search engines A, B and C is different.

For example, the webpage encoding rule could be include UTF-8, GB2312 and etc.

UTF-8 normally generates default UTF-8 encoding, and accordingly default decoding is UTF-8. The webpage encoding rule of GB2312 is similar thereto.

For the decoding of UTF-8 and GB2312, the search engine can be used to determine the webpage encoding rule. Then it is necessary to search and collect in advance the webpage encoding rule to which each search engine is applied.

In addition, in the search keyword information,%xx%xx format is URL encoding (UTF-8 or GB2312); in GB2312 a Chinese character is constituted of two groups of %xx, and in UTF-8 the Chinese character is constituted of three groups of %xx; if UTF-8 decoding mode is used to decode GB2312 codes, messy codes may occur.

Since UTF-8 is constituted of three groups of %xx and GB2312 is constituted of two groups of %xx, if UTF-8 decoding mode is used to decode GB2312 and successfully decode, then a length of decoded character is bound to be shortened. For example, four Chinese characters by the GB2312 URL encoding are “%C7%EF%BA%AE%B2%A9%BF%CD”. When using UTF-8 encoding mode to decode, if successful, the length of decoded characters may be two and half Chinese characters. If failed, it means that the webpage encoding rule is GB2312 encoding mode.

Therefore, following steps can be employed to identify the webpage encoding rule of URL:

1. obtaining search keyword information, wherein it is necessary to translate non-Chinese URL to remove English;

2. getting the number (x) of groups of the search keyword information; for example, the search keyword information “q=%C7%EF%BA%AE%B2%A9%BF%CD” is divided into 8 groups;

3. using UTF-8 decoding mode to decode the obtained encoding string;

4. if the decoding is failed (for example, program failure), then going to Step 8;

5. if successfully decoded, obtaining a length (y) of decoded character string and comparing with a number dividing the group number of overall search keyword information by 3;

6. if x!=y, then going to Step No. 8;

7. if x=y, then using the obtained character string as the search keywords; and

8. decoding with GB2312 mode and using the obtained character string as the search keywords.

In a preferred example of the embodiment of the disclosure, the preset conditions may further comprise:

the current webpage corresponding to the loading request is a verified safe webpage.

In this example, the recommendation information loading identifier may also be a recommendation information loading identifier sent to the browser when the web address security assembly verifies that the current webpage corresponding to the loading request is a safe webpage.

Step 303, in accordance with the search keyword information in Refer information of current webpage and/or web address information of current webpage, requesting recommendation information from a recommendation server corresponding to the browser.

In a specific implementation, the Refer information of current webpage could be information which records a URL corresponding to a search result webpage obtained by submitting search keywords in the search engine.

The web address information of current webpage could be information which records a URL of the current webpage requested to load.

For example, when the user inputs search keywords “mobile phone” on the search engine and opens “XX Encyclopedia” webpage in a search result webpage item, the browser may send following webpage state information to the server:
Refer information of current webpage (which could be represented by “Refer”):
http://so.***.cn/s?ie=utf-8&src=hao_search&q=%E6%89%8B%E6%9C%BA #product-title;
the web address information of current webpage (which could be represented by “Url”):
http://baike.***.com/doc/5339213.html#5339213-5574654-0

Upon the receipt of a request for the recommendation information from the browser, the recommendation server may employ the search keyword information in the Refer information of current webpage and/or the web address information of current webpage to search for the recommendation information corresponding to the webpage state information.

In a preferred embodiment of the disclosure, Step 303 may comprise sub-steps of:

Sub-Step S31, sending the Refer information of current webpage and/or the web address information of current webpage to a recommendation server corresponding to the browser to request for the recommendation information.

The recommendation server is used to perform URL structure analysis by using the URL corresponding to the search result webpage of the Refer information of the current webpage in accordance with the request, extract search keyword field in the URL corresponding to the search result webpage, decode the search keyword field in accordance with a predefined webpage encoding rule to obtain search keywords, and search for the recommendation information corresponding to the search keywords, and/or search for the recommendation information corresponding to web address information of current webpage in the Refer information of current webpage.

For the web address information of current webpage, the recommendation server may obtain a parent webpage layer by layer in accordance with the current webpage URL, then extract a tag of each layer of webpage, extract keywords, and in the end search for the corresponding recommendation information in accordance with the keywords.

For example, the current webpage URL is http://www.***.com/flash/72550.htm, with a webpage tag of the Three Kingdoms Town, which is a kind of flash game; its parent webpage is http://www.***.com/special/1.htm, with a webpage tag of two-player mini-game of the all; its parent webpage of the parent webpage is http://www.***.com/, which is the homepage of website, with a tag of web game platform. The keywords for extraction would be Flash mini-game, and the recommendation information corresponding to the flash mini-game is searched for. For example, top N of the most popular flash mini-games in current network are searched for, wherein N is a positive integer.

For the Refer information of current webpage, the recommendation server may extract the search keywords by the aforesaid method in which the web address security assembly determines the current webpage corresponding to the loading request to be a webpage corresponding to the search result item in the search result webpage of previous search engine, and then search for the corresponding recommendation information in accordance with the search keywords.

In practice, upon the receipt of the recommendation information request sent at the browser side, the recommendation server may search for the recommendation information corresponding to the webpage state information about the current webpage.

In order to increase user viscosity, most of platforms may push a variety of information. In other words, push servers for recommendation information have already been disposed.

However, in this embodiment of the disclosure, the recommendation server could be a individually disposed server; or, individual transfer servers can be disposed and then existing push servers are multiplexed. Therefore, one machine may have multiple functions without individually disposing a set of new recommendation servers, thereby greatly reducing the cost.

In particular, the transfer server can receive the webpage state information sent from the browser, make statistics on the user behavior information, and then send http to the push server to request for NLP (Natural Language Processing) service. The information interaction can be achieved between the transfer server and the push server by a predefined format (for example, proto). The transfer server may decode the recommendation information request and add the information which is not submitted by the browser but necessary for the push server (for example, request IP) to the request for the use of the push server. The push server may search for the recommendation information by using NLP technique, and then the transfer server may return it to the browser.

For example, information of the predefined format proto could include one or more kind of operation information (message StringPair), URL information (message URL), message request body (message ReqBody), message response body (message RespBody), request message (message Request) and response message (message Response), wherein
the operation information (message StringPair) may record required key bytes and optional byte value, such as

```
message StringPair {
    required bytes key = 1;
    optional bytes value = 2;
}
```

The URL information (message URL) may record information about webpage URL sent from the browser, such as byte character (charset), webpage type (type), URL itself (url), webpage server identification (host), hyperlink path (uniurl), webpage title (title). A specific example is as follows:

```
message URL {
    enum Type {
        kT_Unknown = 0;
        kT_Full = 1;
        kT_Intercept = 2; //truncated url
    }
    enum Charset {
        kCS_Unknown  = 0;
        kCS_UTF8  =1;
        kCS_GBK = 2;
        kCS_BIG5 = 3;
    }
    required Charset charset = 1 [default = kCS_Unknown];
    required Type type = 2 [default = kT_Unknown ];
    optional bytes url = 3; // visited url
    optional bytes host = 4;
    optional bytes uniurl = 5; // uniformed url
    optional bytes title = 6; // url-page's title
}
```

The message request body (message ReqBody) may include request message identification (for example, ID), URL type of current webpage (page_url) and Refer information type of current webpage (page_refers), for example. A specific example is as follows:

```
            message ReqBody{
                required int32 id = 1 [default = 0]; // IDs in
the same request need to have the same number from 0
                required int32 ver = 2 [default = 0];
                optional URL page_url = 3; // URL
class, the corresponding title belongs to a URL entity for the convenience
of processing logic of amendments such as url normalization
                repeated URL page_refers = 4;
            }
```

The message response body (message RespBody) may include response message identification (for example, ID), recommendation information identifier (sid) and display data of exhibition window, for example. A specific example is as follows:

```
            message RespBody{
                required int32 id = 1 [default = 0 ]; // correspond
                to ReqBody.id
                required int32 ver = 2 [default = 0 ]; // correspond
                to ReqBody.ver
                required bytes sid = 3 [default = “”]; // server-
                generated session id
//session id generated by transfer server is sent to the browser and
used as a unique ascertained id for the browser to make statistics
and report
                optional bytes html = 4;
                optional bytes tple = 5;
                optional bytes data = 6;
                repeated StringPair ctrl = 7; //used
as control information except for practical content, such as height
            }
```

The request message (message Request) may include request type (ReqType type), product (product), subtype of product (combo), browser version (browser_ver), user identification (mid) and extended information (kv), for example. A specific example is as follows:

```
            message Request{
                enum ReqType{
                    RecommendTip = 0; // default
                }
                required ReqType type = 1 [default = RecommendTip]; //
default request type is current functions to avoid adding function discrimination to a popup
box under a subsequent browser
                required string product = 2 [default = “”]; //product
                required string combo = 3 [default = “”]; // subtype of
product
                required string browser_ver = 4 [default = “”];
                required string mid = 5 [default = “”]; //user ID
                repeated StringPair head = 6; // all stat info //all extended
information and satellite information of other requests are stored herein, such as open: 1,
disable: 0, pop: sid, click=1, clientip=111.111.111.111, for example
                repeated ReqBody body = 7;
            }
```

The response message (message Response) may include head information (head) and body information (body). A specific example is as follows:

```
message Response{
    repeated StringPair head= 1;
    repeated RespBody body= 2;
}
```

Step 304, loading the recommendation information requested from the recommendation server in a browser window of the current webpage at the browser side.

In a specific implementation, the recommendation information may include item data and display attribute data, wherein the item data could be HMTL documents in conformity with a browser definition standard, as substantial contents of the recommendation information; and the display attribute data could be parameter data set for loading an exhibition window of the item data by the recommendation server in accordance with the current browser and the item data.

In a preferred embodiment of the disclosure, Step 304 may comprise sub-steps of:

Sub-Step S41, generating an exhibition window in the browser window of the current webpage at the browser side in accordance with the display attribute data.

In a specific implementation, the display attribute data may be represented by the form of a Key-Value pair. The display attribute data may include a position, height and width of the exhibition window, a position of the item data in the exhibition window, and positions of function keys of the exhibition window in the exhibition window, for example.

For example, the display data may include height:97, which means that the display window has a height of 97px (pixel). In practice, the exhibition window may be generated below the current webpage with a height of 97px and a width in consistent with a main window of the browser; a partition line with a height of 3px is provided on the display window; and the left side of the item data has a 20px distance from a frame of the browser, for example.

Herein, the function keys of exhibition window could include a closing key and a settings key. In a life cycle of the recommendation information, when the user clicks on the closing key, the exhibition window may shut up accordingly and will not display any more. With the settings key, the user may selectively set the exhibition window to be “automatically open” or “manually open”.

Sub-Step S42, receiving the item data sent from the recommendation server.

In a preferred example of the embodiment of the disclosure, the browser side may have a recommendation information identifier corresponding to current recommendation information established at the recommendation server side.

In this example, Step S42 may further comprise sub-steps of:

Sub-Step S421, receiving the item data sent from the recommendation server with respect to the exhibition window and the recommendation information identifier corresponding to the current recommendation information.

The recommendation information identifier (sid) could be an identification number of session established between the recommendation server and the browser. In other words, a unique session identifier is provided between the display window in each browser and the recommendation server, such that the recommendation server can easily transfer the recommendation information with a specified display window in its session.

Sub-Step S43, displaying the item data in the exhibition window.

In a specific implementation, the loading can be performed in accordance with a preset position of the item data by the display attribute data.

It should be explained that, before the HTML texts of the current webpage are completely loaded, the exhibition window can be set to a hidden attribute which includes function keys in non-clickable state. After the HTML texts of the current webpage are completely loaded, when a mouse wheel rolling event within the current webpage is monitored and the recommendation information is set to be “actively start”, then the exhibition window may be popped up directly to display the item data.

The exhibition window may vary according to the width of main window of the browser with the height thereof unchanged. The item data can be self-adapted gradually according to the width of browser. For example, the item data is increased according to the increment in the width; and the item data is reduced according to the reduction in the width.

In a preferred example of the embodiment of the disclosure, the item data could include one or more of following items:
text information, image information, audio information, video information and Flash information.

In particular, the item data could include one or more items. For example, on a left side of the exhibition window, the text information such as “Sun” and “Moon” corresponds to the image information, and on a right side of the exhibition window, “Halley's Comet” and “Titan” only correspond to text information.

Of course, the aforesaid item data is only exemplary. In the implementation of the embodiment of the disclosure, it is possible to set other item data according to the practical situation, which is not restricted by the embodiment of the disclosure.

In the application of the embodiment of the disclosure, each webpage window at the browser side may store the corresponding recommendation information. The browser may be formed of Tab webpage windows. If a webpage loaded in each Tab webpage window conforms to the preset condition, then the recommendation information corresponding to the current webpage may be loaded.

With reference to FIG. 4, it shows a flowchart of steps of a second method example for loading recommendation information of search result according to an embodiment of the disclosure. The method may particularly comprise steps of:

Step 401, initiating a loading request of a current webpage at a browser side.

Step 402, determining the receipt of a recommendation information loading identifier sent with respect to the loading request from a web address security assembly in a computer system where the browser is located, wherein the recommendation information loading identifier is a recommendation information loading identifier sent to the browser when the web address security assembly determines the current webpage corresponding to the loading request to be a webpage corresponding to a search result item in a search result webpage of a previous search engine.

Step 403, in accordance with the search keyword information in Refer information of current webpage and/or web address information of current webpage, requesting recommendation information from a recommendation server corresponding to the browser.

Step 404, sending extended information which records setting parameters when previously loading other recommendation information to the recommendation server, wherein the recommendation server is used to make statistics on user behavior information by the extended information and in accordance with the user behavior information, return corresponding recommendation information to the browser side requesting for the recommendation information.
the extended information (which could be represented by “KV”, i.e., Key-Value pair):
it could be used for extended functions of the browser.

In an optional example according to this embodiment of the disclosure, the extended information may include one or more types as follows:
an exhibition parameter, an opening parameter, a closing parameter and a recommendation information identifier, wherein
the exhibition parameter could be a parameter which records exhibited or non-exhibited recommendation information when the recommendation information is loaded;
the opening parameter could be a parameter which records manual opening or automatic opening of loading the recommendation information;
the closing parameter could be a parameter which records manually closed or unclosed recommendation information when the recommendation information is loaded;
the recommendation information identifier could be a session established between the browser and the recommendation server when the identifier loads the recommendation information.

For example, the extended information (which could be represented by “KV”, i.e., Key-Value pair) may include:
the exhibition parameter (which could be represented by “Show”):
“0” may represent “non-exhibited”, and “1” may represent “exhibited”;
the opening parameter (which could be represented by “Open”):
“1” may represent that the recommendation information is automatically opened, and “2” may represent that the recommendation information is manually opened;
the closing parameter (which could be represented by “Close”):
“1” may represent that the recommendation information is manually closed;
the recommendation information identifier (which could be represented by “Sid”):
it is a unique ID of the recommendation information, which could be assigned by the recommendation server, such as 1001.

In practice, by the extended information, the browser may send the information which records setting parameters when other recommendation information is previously loaded to the recommendation server; the recommendation server may be used to make statistics on user behavior information by the extended information, and in accordance with the user behavior information, return corresponding recommendation information to the browser side requesting for the recommendation information. For example, in the case that a certain kind of recommendation information is frequently manually closed by the user, the recommendation server may exclude this kind of recommendation information from the preset condition and no longer recommend it.

In this embodiment of the disclosure, by the user behavior information, the information which is suitable to be recommended and which is not suitable to be recommended can be determined, thus following user's behavior habits, satisfying user's demands and increasing the use efficiency of the recommendation server, the browser and the bandwidth.

Step 405, loading the recommendation information requested from the recommendation server in a browser window of the current webpage at the browser side.

Step 406, when the recommendation information is triggered, initiating a search request on the search engine by using the recommendation information.

In a specific implementation, a trigger point is embedded in the item data. When the user selects an item of the item data by a mouse click or a special function key, then the text information corresponding to the item data may be used to initiate the search request on the search engine.

Step 407, loading a search result obtained by using the recommendation information to search in accordance with the search request through the search engine.

In a specific implementation, the browser may newly open a webpage window, and the search result returned by the search engine may be loaded.

In this embodiment of the disclosure, each URL corresponding to the search result webpage initiated by the recommendation information may have a uniform src identifier to identify that the search is initiated by the recommendation information. The search engine may make statistics on the corresponding user behavior information such as UV (unique visitor, which refers to different natural persons browsing this webpage by accessing the Internet) and PV (Page View, which refers to page views or click rates wherein one is recorded every time a user visits each webpage in a website) and then send it to the recommendation server. The recommendation server may return corresponding recommendation information to the browser side where the recommendation information is requested in accordance with the user behavior information. For example, a URL of a search result webpage initiated by the recommendation information could be as follows:
http://www.***.com/s? src=se_related&q=%E8%81%94%E9%80%9A%E4% B8%8A%E8%B0%83%E9%87%91%E9%93%B6iPhone%205s%E5%90%88%E7%BA%A 6%E4%BB%B7
wherein, “src=se_related” is the src identifier.

According to the disclosure, in response to the request of loading the current webpage, the method may receive the recommendation information loading identifier, request for the recommendation information on the recommendation server and load it in the browser window, and load webpage behavior to obtain the recommendation information according to user's request, thereby increasing coverage of the recommendation information and satisfying with user's demand with an improved practicability. Therefore the recommendation information can more exactly reflect the user's personalized interests and hobbies, whereby pushing news information to improve the matching ratio of the user's interests and hobbies with the recommendation information. The user may obtain his or her interested recommendation information without manually searching for and filtering information, thereby reducing operation steps of search, comparison and filtration for obtaining interested information and improving efficiency of obtaining user's interested information. In the meanwhile, since user's operation steps are reduced, the resource consumption of the browser and server can be reduced and accordingly the occupation of network resource can be lowered.

With reference to FIG. 5, it shows a flowchart of steps of a second method example for detecting web address according to an embodiment of the disclosure. The method may particularly comprise steps of:

Step 501, at a web address security assembly, monitoring that a browser in a computer system of a query assembly initiates a loading request of current webpage.

Step 502, extracting web address information of current webpage from the loading request.

In a specific implementation, the web address security assembly may monitor a webpage loading request by a specified response event interface. For example, when, by the specified response event interface achieving a standard plug-in mechanism, a URL of webpage corresponding to the web address requested to visit by the browser is obtained, it is indicated that the loading request of current webpage initiated by the browser is monitored. For example, in a Trident kernel browser, such as an IE (Internet Explorer) browser, a Browser Helper Object (BHO) plug-in mechanism can be used, and by responding to a “BeforeNavigate2” event, a webpage web address currently being loaded by the browser can be obtained. In a Webkit kernel browser, such as a Chrome browser, a Netscape Plug-in Application Programming Interface (NPAPI) plug-in mechanism can be used to obtain a web address currently being loaded by the browser.

Or, in response to a request of loading webpage, the browser may first send the request of loading webpage to the web address security assembly.

Step 503, performing security verification on the current webpage by using the web address information and determining the current webpage to be a safe webpage. In practice, the web address security assembly may first perform a normalized processing on the current webpage URL. For example, uppercase and lowercase letters in web address (including information, such as protocol, host name, path name, file name and parameter) are unified, and redundant path symbols and parameters in the URL are removed.

For example, the current webpage URL is: HTTp://www.A.com//aBc/abc.Php?A=1;

The uppercase and lowercase letters therein are unified to be lowercase letters: http://www.a com//abc/abc.php?a=:1;

The redundant path symbols are removed as follows: http://www.a.com/abc/abc.php?a=1;

Then, the web address security assembly may extract web address cipher text corresponding to the current webpage URL. For the web address, three types of key information are URL itself (url), host name of web address (host) and first domain name section of web address (domain name).

In particular, the host name could be a host part with the removal of information such as path symbol, protocol head and port number in the URL, and the first domain name section could be traced back level by level from right to left according to the host name of URL. Optionally, when obtaining the first domain name section, a maximum 7 levels can be traced back from right to left.

If a right-to-left first level root domain name of the host name of the current webpage URL is an international top-level domain name, then the first domain name section of the current webpage URL is a first level sub-domain name of the host name of the current webpage URL. Herein, the international top-level domain name may refer to common top-level domain name such as “com”, “net”, “org”, “edu” and “gov”. For example, the host name of the current webpage URL is www.a.com, the first level root domain name is “com”, and then its first level sub-domain name “a.com” may be extracted to be the first domain name section of the current webpage URL.

If the right-to-left first level root domain name of the host name of the current webpage URL is a country code top-level domain name and the first level sub-domain name includes international top-level domain name, then the first domain name section of the current webpage URL is a second level sub-domain name of the host name of the current webpage URL. Herein, the country code top-level domain name may refer to special top-level domain name such as “cn” and “hk”. For example, the host name of the current webpage URL is www.a.com.cn, its right-to-left first level root domain name is “cn”, the first level sub-domain name is “com.cn”, and then its second level sub-domain name “a.com.cn” may be extracted to be the first domain name section of the current webpage URL.

If the host name of the current webpage URL uses a dynamic domain name, then the first domain name section of the current webpage URL is a next level sub-domain name of the host name of the current webpage URL extracted from the dynamic domain name towards right hand. Herein, the dynamic domain name refers to some second or third level dynamic domain names, such as “3322.org”, “s.3322.org” and “s.3322.nct” dynamic domain name. For example, the host name of the current webpage URL is www.a.3322.org wherein a dynamic domain name “3322.org” is used, then next level sub-domain name “a.3322.org” is extracted from the dynamic domain name towards right hand to be the first domain name section of the current webpage URL.

In this embodiment of the disclosure, after the current webpage URL is obtained, feature values of any one or more of the three types of information, such as host name of URL and the first domain name section, can be extracted to be the cipher text. Optionally, the feature value could be a Hash value. Particularly, the feature value could be a Hash value calculated on the basis of Message Digest Algorithm fifth edition, (md5), or a feature code capable of uniquely identifying original information (url, host, domain name) such as SIIA1 code or CRC (Cyclic Redundancy Check) code. In following examples, description will be given by way of 32-bit md5 Hash value.

For example, the current webpage URL is: http://www.a.com/abc/abc.php?a=1; according to above method, the obtained host name of the current webpage URL is: www.a.com; and the obtained first domain name section of the current webpage URL is: a.com.

Calculated 32-bit md5 Hash value of the current webpage URL itself is:
md5(http://www.a.com/abc/abc.php?a=1,32)=e2a6b69ffl5c6a8c276f089250a b3f7d

Calculated 32-bit md5 Hash value of the host name of the current webpage URL is:
md5 (www.a.com,32)=30f4a7bbefe70d75616707c80921a7c8

Calculated 32-bit md5 Hash value of the first domain name section of the current webpage URL is:
md5 (a.com,32)=b3655bd7aad56513fcdacbd4254ed6b7

The above calculated 32-bit md5 Hash value of the current webpage URL, the 32-bit md5 Hash value of the host name of the current webpage URL and the 32-bit md5 Hash value of the first domain name section of the current webpage URL are the web address cipher texts of the current webpage URL.

In above example where the current webpage URL is: http://www.a.com/abc/abc.php?a=1, an obtained set of web address cipher texts of the current webpage URL could be as follows:
domain name |host|url
a.com|www.a.com|http://www.a.com/abc/abc.php?a=1
b3655bd7aad56513fcdacbd4254ed6b7|30f4a7bbefe70d75616707c80921a7c8|e2a6b69ffl5c6a8e276f089250ab3f7d

Next, the web address security assembly may use the web address cipher text corresponding to the current webpage URL to match in a cipher text database. If the web address cipher text corresponding to the current webpage URL matches with a cipher text which is stored in the cipher text database and which is marked as a malicious web address, then the current webpage could be determined to be a dangerous webpage; if the web address cipher text corresponding to the current webpage URL matches with a cipher text which is stored in the cipher text database and which is marked as a safe web address, then the current webpage could be determined to be a safe webpage.

It should be explained that the cipher text database stores cipher texts marked as malicious web address and/or safe web address in advance. These cipher texts may be obtained from a great number of known URLs of malicious web address and/or safe web address. Optionally, data key values in the cipher text database may be stored in accordance with feature values of three types of key information (web address url, the web address host and the web address domain name). The key values of the three types of key information may be marked on the basis of safe web address and malicious web address, respectively. In particular, the cipher text marked as malicious web address may include one or more types of following information: a feature value of malicious URL, a feature value of the host name of malicious URL and a feature value of the first domain name section of malicious URL. The cipher text marked as safe web address may include one or more types of following information: a feature value of safe URL, a feature value of the host name of safe URL and a feature value of the first domain name section of safe URL.

The cipher text database may be locally stored in the web address security assembly or in a specified cipher text server.

With the application of this embodiment of the disclosure, the cipher text server may send information in the cipher text database to the web address security assembly to update the local cipher text database at preset time (for example, 6:00 am every morning and 12:00 am every Saturday).

In the embodiment of the disclosure, the web address security assembly may first perform a security verification on the current webpage. When the current webpage is determined to be a safe webpage, a subsequent determination on a webpage corresponding to the search result item may be performed.

Step 504, determining whether the current webpage corresponding to the loading request is a webpage corresponding to the search result item in the search result webpage of pervious search engine, and if yes, proceed to Step 305.

In a specific implementation, the web address security assembly may perform a structural analysis on the current webpage URL, extract search keyword information in the URL, and decode the search keyword information in accordance with a predefined webpage encoding rule; and when successfully decoded, the current webpage may be determined to be a webpage corresponding to the search result item in the search result webpage of search engine.

Step 505, generating a recommendation information loading identifier;

In a preferred embodiment of the disclosure, the recommendation information loading identifier may also be a recommendation information loading identifier sent to the browser when the web address security assembly verifies that the current webpage corresponding to the loading request is a safe webpage.

For the determination on the loading request of current webpage by the preset conditions for example in consistent with the webpage corresponding to the search result item and the safe webpage, the web address security assembly may generate the recommendation information loading identifier and return it to the browser.

For example, information generated by the web address security assembly with respect to the loading request of current webpage may include:
{v:0}{ot:1369125047}{st:20}{ch:0}{wd.info:c2M9MTAw}{trust.info:e2Q6 MzYwLmNufXt6OjZ9e3Q6MTAwNH17bTo4NWUwNjgOMzBjODcyM2VkYTczYjdhYjYz MTFiYTU2YX17bjozNjDlrpjnvZF9e2k6MX17YzoyfQ==}{child.info:bGV2ZWw9d2hpdG U=}{icp.info:e2Q6MzYwLmNufXt0OjEwMDR9e3Y6MS4wfXtwOip9}{xf.info:MAkxMzY 5MTI5ODc1CTEwMg==}{yx.info:e2g6MzYwLmNufXtjOjQwNDZ9e2U6MTcxfXtnczo4O H17czE6Mzc3NH17czI6MTc3fXtzMzo0NDd9e2kxOjc2N317aTI65a6J5YWoXzczNDB8fO awuOi/nOaUr+aMgTM2MF82OTA3fHz1hY3otLlfNjE2NXx85p2A5q+SXzQ1MDZ9}{tip.info:cmVxPTE=}

Herein, tip.info is an information field returned upon the determination of the preset conditions by the loading request of current webpage to which the web address security assembly is directed. If req=1, then it is a recommendation information loading identifier, indicating there is an allowance for requesting the recommendation information on the recommendation server; if req=0, then it indicates there is no allowance for requesting the recommendation information from the recommendation server. Of course, in the embodiment of the disclosure, the situations wherein req=2 and req=3 may be included. For example, existing data is used to determine that the loading of a webpage allows to request the recommendation information from the recommendation server. However, in a special situation that the current network is unstable or the webpage is attacked, then the web address security assembly may temporarily configure the loading request of the webpage to be req=2 without modifying existing data, indicating there is no allowance for requesting the recommendation information from recommendation server. After the special situation is eliminated, the loading request of the webpage may be determined according to the existing data.

Upon the determination on the loading request by the preset conditions such as the webpage corresponding to the search result item and the safe webpage, the disclosure may not allow the loading request inconsistent with the preset conditions to request the recommendation information, while allowing the loading request consistent with the preset conditions to request the recommendation information, thereby greatly reducing the requests for the recommendation information from the recommendation server and significantly lowering the resource occupation of the recommendation server.

Step 506, sending the recommendation information loading identifier to the browser, wherein the browser is used to request recommendation information from a recommendation server corresponding to the browser in accordance with the search keyword information in the Refer information of current webpage and/or the web address information of current webpage and to load the recommendation information requested from the recommendation server in the browser window of the current webpage at the browser side.

The web address security assembly may send the generated information at least including the recommendation information loading identifier to the browser, and the browser may carry on decoding in accordance with the predefined rule and then perform subsequent loading operation based on a decoded instruction.

The method embodiments, for the purpose of brief description, are described as a series of combined actions. However, it should be appreciated by those skilled in the art that the embodiments of the disclosure should not be restricted by the sequence of the actions as set forth, since some of actions could be performed in different sequence or simultaneously according to the embodiments of the disclosure. Moreover, it should also be appreciated by those skilled in the art that, the embodiments as described in the specification are preferred embodiments and actions concerned are not necessarily required in the embodiments of the disclosure.

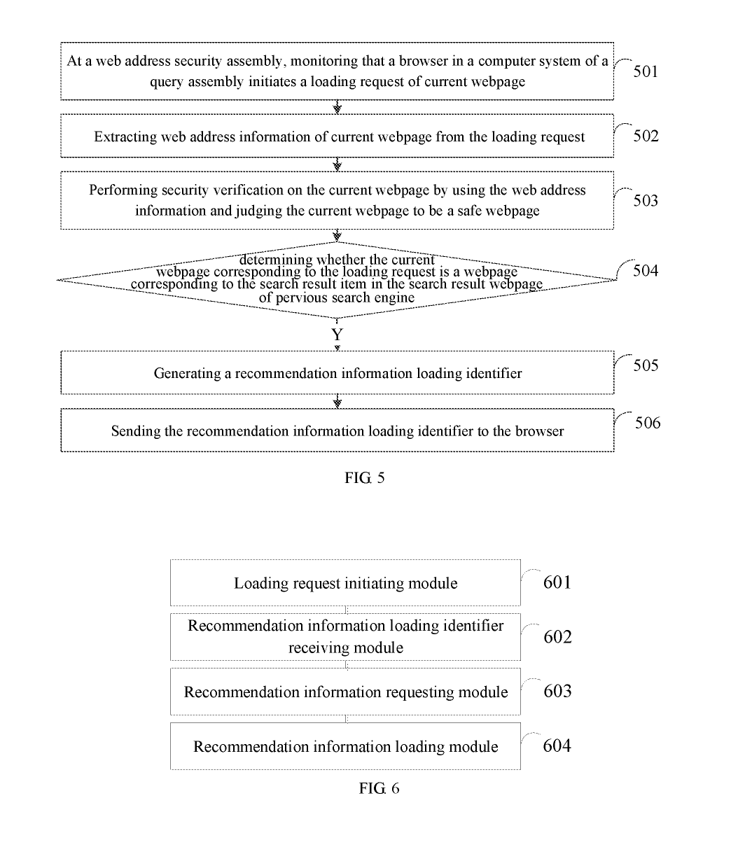

With reference to FIG. 6, it shows a block diagram of a device for loading recommendation information according to an embodiment of the disclosure. The device may comprise following modules:
a loading request initiating module 601, configured to initiate a loading request of a current webpage at a browser side;
a recommendation information loading identifier receiving module 602, configured to receive a recommendation information loading identifier sent with respect to the loading request from a web address security assembly in a computer system where the browser is located, wherein the recommendation information loading identifier is a recommendation information loading identifier generated when the web address security assembly determines that the loading request conforms to a preset condition;
a recommendation information requesting module 603, configured to, in accordance with webpage state information about the current webpage, requesting recommendation information from a recommendation server corresponding to the browser; and
a recommendation information loading module 604, configured to load the recommendation information requested from the recommendation server in a browser window of the current webpage at the browser side.

In a preferred embodiment of the disclosure, the preset condition may include:
the current webpage corresponding to the loading request is a webpage corresponding to a search result item in a search result webpage of search engine;
and/or,
the current webpage corresponding to the loading request is a specified webpage;
and/or,
the current webpage corresponding to the loading request is a verified safe webpage.

In a preferred embodiment of the disclosure, the webpage state information may include one or more types:
Refer information of the current webpage, web address information of the current webpage, title information, identification information of computer hardware and extended information, wherein
the Refer information of current webpage could be information which records a URL corresponding to a search result webpage obtained by submitting search keywords in the search engine;
the web address information of current webpage could be information which records a URL of the current webpage requested to load;
the title information could be information which records a title corresponding to the current webpage requested to load;
the identification information of computer hardware could be information which identifies computer hardware where the browser is located; and
the extended information could include information which records setting parameters when other recommendation information is previously loaded.

In a preferred embodiment of the disclosure, the extended information may include one or more types:
an exhibition parameter, an opening parameter, a closing parameter and a recommendation information identifier, wherein
the exhibition parameter could be a parameter which records exhibited or non-exhibited recommendation information when the recommendation information is loaded;
the opening parameter could be a parameter which records manual opening or automatic opening of loading the recommendation information;
the closing parameter could be a parameter which records manually closed or unclosed recommendation information when the recommendation information is loaded;
the recommendation information identifier could be a session established between the browser and the recommendation server when the identifier loads the recommendation information.

In a preferred embodiment of the disclosure, the recommendation information requesting module 603 may be further configured to:
when the current webpage is a specified webpage, use the webpage state information at least including the web address information of the current webpage to request the recommendation information from the recommendation server corresponding to the browser, wherein the server is used to search for the recommendation information corresponding to the web address information of the current webpage in accordance with the request;
and/or,
when the current webpage is loaded, use the webpage state information at least including the title information to request the recommendation information from the recommendation server corresponding to the browser, wherein the server is used to search for the recommendation information corresponding to the title information in accordance with the request;
and/or,
when the current webpage is the search result webpage of the search engine, use the webpage state information at least including the Refer information of the current webpage to request the recommendation information from the recommendation server corresponding to the browser, wherein the server is used to perform a URL structure analysis by the Refer information of the current webpage in accordance with the request, to extract search keyword information from the URL of the current webpage, to decode the search keyword information in accordance with a predefined webpage encoding rule to obtain the search keywords, and to search for the recommendation information corresponding to the search keywords.

In a preferred embodiment of the disclosure, the recommendation information may include item data and display attribute data.

The recommendation information loading module 604 may also be configured to:
generate an exhibition window in the browser window of the current webpage at the browser side in accordance with the display attribute data;
receive the item data sent from the recommendation server; and
display the item data in the exhibition window.

In a preferred embodiment of the disclosure, the browser side may have a recommendation information identifier corresponding to current recommendation information established at the recommendation server side.

The recommendation information loading module 604 may also be configured to:

receive the item data sent from the recommendation server with respect to the exhibition window and the recommendation information identifier corresponding to the current recommendation information.

In a preferred embodiment of the disclosure, the item data could include one or more of following types:
text information, image information, audio information, video information and Flash information.

In a preferred embodiment of the disclosure, each webpage window at the browser side may store the corresponding recommendation information.

In a preferred embodiment of the disclosure, the device may further comprise following modules:
a search request initiating module, configured to, when the recommendation information is triggered, initiate a search request on the search engine by the recommendation information; and
a search result loading module, configured to load a search result obtained by using the recommendation information to search in accordance with the search request through the search engine.

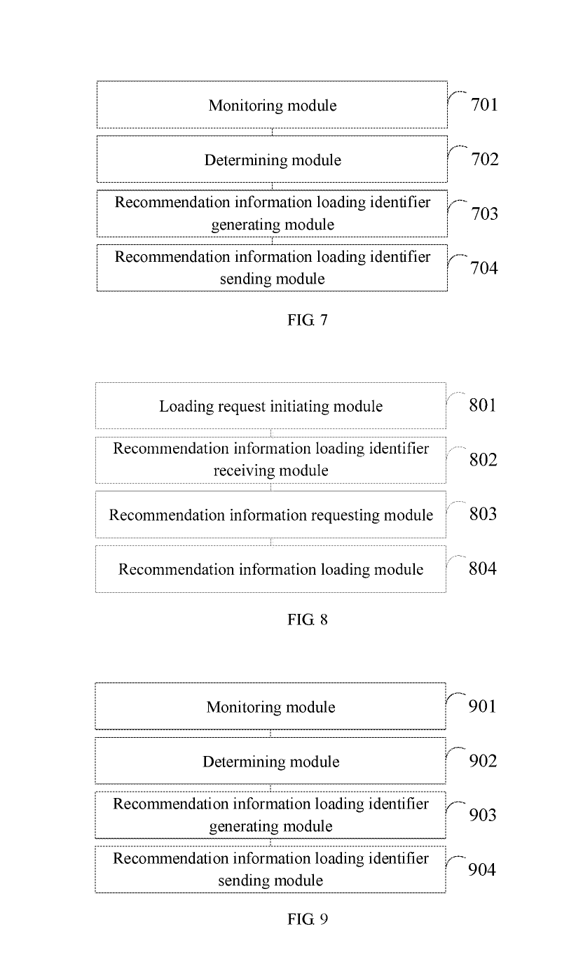

With reference to FIG. 7, it shows a block diagram of a first device example for detecting web address according to an embodiment of the disclosure. The device may particularly comprise following modules:
a monitoring module 701, configured to, at a web address security assembly side, monitor that a browser in a computer system where a web address security assembly is located initiates a loading request of current webpage;
a determining module 702, configured to determine whether the loading request conforms to a preset condition, and if yes, invoke a recommendation information loading identifier generating module 703;
a recommendation information loading identifier generating module 703, configured to generate a recommendation information loading identifier; and
a recommendation information loading identifier sending module 704, configured to send the recommendation information loading identifier to the browser, wherein the browser is used to request for the recommendation information from its corresponding recommendation server in accordance with webpage state information about the current webpage and load the recommendation information requested from the recommendation server in a browser window of the current webpage at the browser side.

In a preferred embodiment of the disclosure, the preset condition may include:
the current webpage corresponding to the loading request is a webpage corresponding to a search result item in a search result webpage of previous search engine;
and/or,
the current webpage corresponding to the loading request is a specified webpage.

In a preferred embodiment of the disclosure, the device may further comprise following modules:
a web address information extracting module, configured to extract web address information of the current webpage from the loading request; and
a verifying module, configured to perform security verification on the current webpage by using the web address information and determine the current webpage to be a safe webpage.

With reference to FIG. 8, it shows a block diagram of a device example for loading recommendation information of search result according to an embodiment of the disclosure. The device may particularly comprise following modules:
a loading request initiating module 801, configured to initiate a loading request of a current webpage at a browser side;
a recommendation information loading identifier receiving module 802, configured to determine the receipt of a recommendation information loading identifier sent with respect to the loading request from a web address security assembly in a computer system where the browser is located, wherein the recommendation information loading identifier is a recommendation information loading identifier sent to the browser when the web address security assembly determines the current webpage corresponding to the loading request to be a webpage corresponding to a search result item in a search result webpage of a previous search engine;
a recommendation information requesting module 803, configured to, in accordance with the search keyword information in Refer information of current webpage and/or web address information of current webpage, request recommendation information from a recommendation server corresponding to the browser; and
a recommendation information loading module 804, configured to load the recommendation information requested from the recommendation server in a browser window of the current webpage at the browser side.

In a preferred embodiment of the disclosure, the loading request may include a current webpage URL, and the web address security assembly may be used to perform a structural analysis on the current webpage URL, extract search keyword information in the URL, and decode the search keyword information in accordance with a predefined webpage encoding rule. When successfully decoded, the current webpage may be determined to be a webpage corresponding to the search result item in the search result webpage of search engine.

In a preferred embodiment of the disclosure, the recommendation information loading identifier may also be a recommendation information loading identifier sent to the browser when the web address security assembly verifies that the current webpage corresponding to the loading request is a safe webpage.

In a preferred embodiment of the disclosure, the device may also comprise a following module:
an extended information sending module, configured to send extended information which records setting parameters when previously loading other recommendation information to the recommendation server, wherein the recommendation server is used to make statistics on user behavior information by the extended information and in accordance with the user behavior information, return corresponding recommendation information to the browser side requesting for the recommendation information.

In a preferred embodiment of the disclosure, the extended information may include one or more types as follows:
an exhibition parameter, an opening parameter, a closing parameter and a recommendation information identifier, wherein
the exhibition parameter could be a parameter which records exhibited or non-exhibited recommendation information when the recommendation information is loaded;
the opening parameter could be a parameter which records manual opening or automatic opening of loading the recommendation information;
the closing parameter could be a parameter which records manually closed or unclosed recommendation information when the recommendation information is loaded; and
the recommendation information identifier could be a session established between the browser and the recommendation server when the identifier loads the recommendation information.

In a preferred embodiment of the disclosure, the recommendation information requesting module 803 may be further configured to:
send the Refer information of current webpage and/or the web address information of current webpage to a recommendation server corresponding to the browser to request for the recommendation information, wherein
the Refer information of current webpage could be information which records a URL corresponding to a search result webpage obtained by submitting search keywords in the search engine;
the web address information of current webpage could be information which records a URL of the current webpage requested to load; and
the recommendation server is used to perform URL structure analysis by using the URL corresponding to the search result webpage of the Refer information of the current webpage in accordance with the request, extract search keyword field in the URL corresponding to the search result webpage, decode the search keyword field in accordance with a predefined webpage encoding rule to obtain search keywords, and search for the recommendation information corresponding to the search keywords, and/or search for the recommendation information corresponding to web address information of current webpage in the Refer information of current webpage

In a preferred embodiment of the disclosure, the recommendation information may include item data and display attribute data.

The recommendation information loading module 804 may also be configured to:
generate an exhibition window in the browser window of the current webpage at the browser side in accordance with the display attribute data;
receive the item data sent from the recommendation server; and
display the item data in the exhibition window.

In a preferred embodiment of the disclosure, the browser side may have a recommendation information identifier corresponding to current recommendation information established at the recommendation server side.

The recommendation information loading module 804 may also be configured to:

receive the item data sent from the recommendation server with respect to the exhibition window and the recommendation information identifier corresponding to the current recommendation information.

In a preferred embodiment of the disclosure, the item data could include one or more of following types:
text information, image information, audio information, video information and Flash information.

In a preferred embodiment of the disclosure, each webpage window at the browser side may store the corresponding recommendation information.

In a preferred embodiment of the disclosure, the device may further comprise following modules:
a search request initiating module, configured to, when the recommendation information is triggered, initiate a search request on the search engine by the recommendation information; and
a search result loading module, configured to load a search result obtained by using the recommendation information to search in accordance with the search request through the search engine.

With reference to FIG. 9, it shows a block diagram of a second device example for detecting web address according to an embodiment of the disclosure. The device may particularly comprise following modules:
a monitoring module 901, configured to, at a web address security assembly, monitor that a browser in a computer system of a query assembly initiates a loading request of current webpage;
a determining module 902, configured to determine whether the current webpage corresponding to the loading request is a webpage corresponding to the search result item in the search result webpage of pervious search engine, and if yes, invoke a recommendation information loading identifier generating module 903;
a recommendation information loading identifier generating module 903, configured to generate a recommendation information loading identifier; and
a recommendation information loading identifier sending module 904, configured to send the recommendation information loading identifier to the browser, wherein the browser is used to request recommendation information from a recommendation server corresponding to the browser in accordance with the search keyword information in the Refer information of current webpage and/or the web address information of current webpage and to load the recommendation information requested from the recommendation server in the browser window of the current webpage at the browser side.

In a preferred embodiment of the disclosure, the device may further comprise following modules:
a web address information extracting module, configured to extract web address information of the current webpage from the loading request; and
a verifying module, configured to perform security verification on the current webpage by using the web address information and determine the current webpage to be a safe webpage.

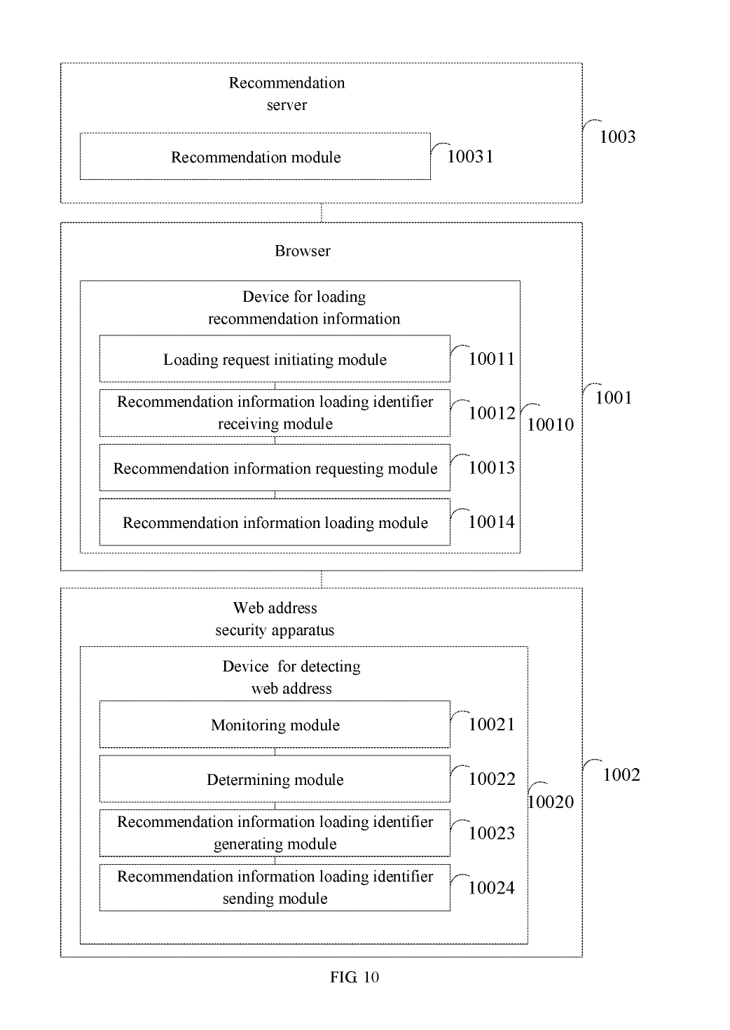

With reference to FIG. 10, it shows a block diagram of a system example for loading recommendation information according to an embodiment of the disclosure. The system may comprises a browser 1001, a web address security apparatus 1002 and a recommendation server 1003, wherein
the browser 1001 could include a device 10010 for loading recommendation information, and the device 10010 for loading recommendation information may comprise following modules:
a loading request initiating module 10011, configured to initiate a loading request of a current webpage at a browser side;
a recommendation information loading identifier receiving module 10012, configured to receive a recommendation information loading identifier sent with respect to the loading request from a web address security assembly in a computer system where the browser is located;
a recommendation information requesting module 10013, configured to, in accordance with webpage state information about the current webpage, request recommendation information from a recommendation server corresponding to the browser; and
a recommendation information loading module 10014, configured to load the recommendation information requested from the recommendation server in a browser window of the current webpage at the browser side.

The web address security apparatus 1002 may include a device 10020 for detecting web address 10020, and the device for detecting web address may comprise following modules:
a monitoring module 10021, configured to monitor that a browser in a computer system where a web address security assembly is located initiates a loading request of current webpage at a web address security assembly side;
a determining module 10022, configured to determine whether the loading request conforms to a preset condition, and if yes, invoke a recommendation information loading identifier generating module 10023;
a recommendation information loading identifier generating module 10023, configured to generate a recommendation information loading identifier; and
a recommendation information loading identifier sending module 10024, configured to send the recommendation information loading identifier to the browser.

Functions and operation state of relevant modules are omitted herein. Reference could be made to related part in the aforesaid embodiments.

The recommendation server 1003 may store one or more pieces of recommendation information. The recommendation server 1003 may comprise following a module:
a recommendation module 10031, configured to, when receiving a request for recommendation information sent from the browser side, search for the recommendation information corresponding to the webpage state information about the current webpage.

It should be explained that the web address security apparatus and the browser may be provided in the same computer (computing device) equipment.

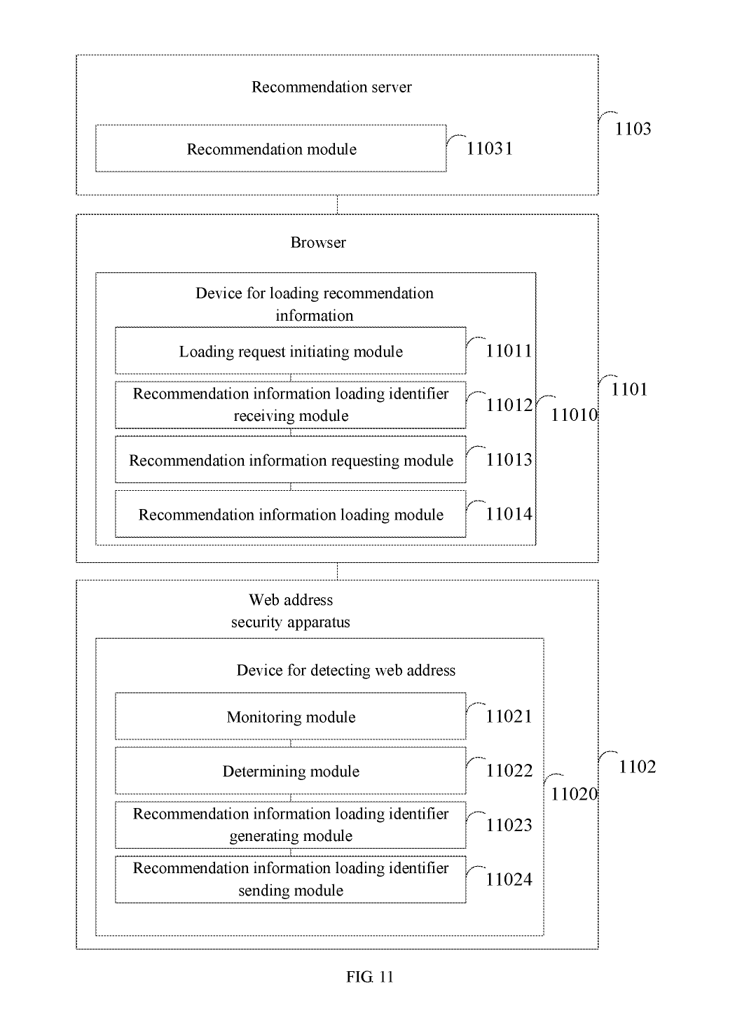

With reference to FIG. 11, it shows a block diagram of a system example for loading recommendation information according to an embodiment of the disclosure. The system may comprise a browser 1101, a web address security apparatus 1102 and a recommendation server 1103, wherein
the browser 1101 may include a device 11010 for loading recommendation information of search result and the device 11010 for loading recommendation information of search result may comprise following modules:
a loading request initiating module 11011, configured to initiate a loading request of a current webpage at a browser side;
a recommendation information loading identifier receiving module 11012, configured to determine the receipt of a recommendation information loading identifier sent with respect to the loading request from a web address security assembly in a computer system where the browser is located;
a recommendation information requesting module 11013, configured to, in accordance with the search keyword information in Refer information of current webpage and/or web address information of current webpage, request recommendation information from a recommendation server corresponding to the browser; and
a recommendation information loading module 11014, configured to load the recommendation information requested from the recommendation server in a browser window of the current webpage at the browser side.

The web address security apparatus 1102 may comprise a device 11020 for detecting web address, and the device 11020 for detecting web address 11020 may comprise following modules:
a monitoring module 11021, configured to, at a web address security assembly, monitor that a browser in a computer system of a query assembly initiates a loading request of current webpage;
a determining module 11022, configured to determine whether the current webpage corresponding to the loading request is a webpage corresponding to the search result item in the search result webpage of pervious search engine, and if yes, invoke a recommendation information loading identifier generating module;
a recommendation information loading identifier generating module 11023, configured to generate a recommendation information loading identifier; and
a recommendation information loading identifier sending module 11024, configured to send the recommendation information loading identifier to the browser.

The recommendation server 1103 may store one or more pieces of recommendation information. The recommendation server 63 may comprise following a module:
a recommendation module 11031, configured to, when receiving a request for recommendation information sent from the browser side, search for the recommendation information corresponding to the webpage state information about the current webpage.

It should be explained that the web address security apparatus and the browser may be provided in the same computer (computing device) equipment. Since the embodiments of the device, the browser and the system are substantially similar to the method embodiments, the description thereof is relatively simple. Therefore, reference could be made to related parts of the method embodiments.

Each of components according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the components in the devices for loading recommendation information, detecting web address and loading recommendation information of search result according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the Internet websites, or be provided in carrier, or be provided in other manners.

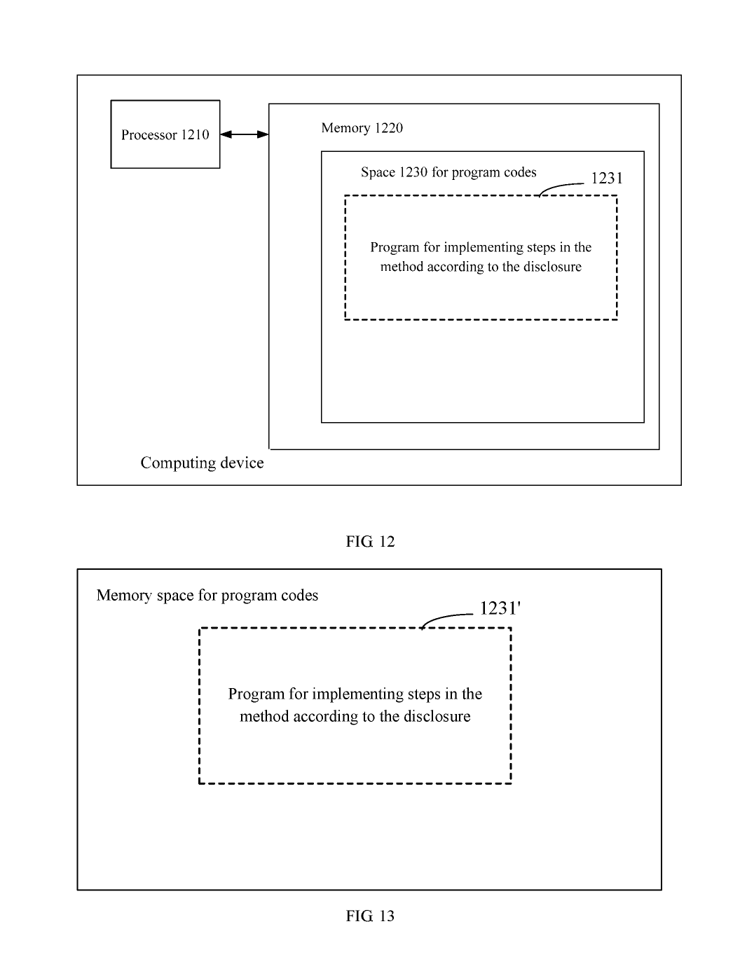

For example, FIG. 12 illustrates a computing device which may implement the loading of recommendation information, the detection of web address and the loading of recommendation information of search result according to this disclosure, such as an application server. Traditionally, the computing device includes a processor 1210 and a computer program product or a computer readable medium in the form of a memory 1220. The memory 1220 could be electronic memories such as flash memory, EEPROM (Electrically Erasable Programmable Read-Only Memory), EPROM, hard disk or ROM. The memory 1220 has a memory space 1230 for executing program codes 1231 of any steps in the above methods. For example, the memory space 1230 for program codes may include program codes 1231 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 13. The memory cells may be provided with memory sections, memory spaces, etc., similar to the memory 1220 of the electronic device as shown in FIG. 12. The program codes may be compressed for example in an appropriate form. Usually, the memory cell includes computer readable codes 1231′ which could be readable for example by the processor 1210. When these codes are operated on the computing device, the computing device may execute respective steps in the method as described above.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

It should be noted that the above-described embodiments are intended to illustrate but not to limit the disclosure, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims.

1. A method for loading recommendation information, comprising:
initiating a loading request of a current webpage at a browser side;
receiving a recommendation information loading identifier sent with respect to the loading request from a web address security assembly in a computer system where the browser is located, wherein the recommendation information loading identifier is a recommendation information loading identifier generated when the web address security assembly determines that the loading request conforms to a preset condition;
in accordance with webpage state information about the current webpage, requesting recommendation information from a recommendation server corresponding to the browser; and
loading the recommendation information requested from the recommendation server in a browser window of the current webpage at the browser side.

2. The method according to claim 1, wherein the preset condition comprises:
the current webpage corresponding to the loading request is at least one of a webpage corresponding to a search result item in a search result webpage of search engine, and a verified safe webpage.

3. The method according to claim 1, wherein the webpage state information comprises at least one of:
refer information of the current webpage, search keyword information in the refer information of the current webpage, web address information of the current webpage, title information, identification information of computer hardware and extended information, wherein
the refer information of the current webpage is information which records a URL corresponding to a search result webpage obtained by submitting search keywords in the search engine;
the web address information of the current webpage is information which records a URL of the current webpage requested to load;
the title information is information which records a title corresponding to the current webpage requested to load;
the identification information of computer hardware is information which identifies computer hardware where the browser is located; and
the extended information includes information which records setting parameters when other recommendation information is previously loaded.

4. The method according to claim 3, wherein the extended information comprises at least one of:
an exhibition parameter, an opening parameter, a closing parameter and a recommendation information identifier, wherein
the exhibition parameter is a parameter which records exhibited or non-exhibited recommendation information when the recommendation information is loaded;
the opening parameter is a parameter which records manual opening or automatic opening of loading the recommendation information;
the closing parameter is a parameter which records manually closed or unclosed recommendation information when the recommendation information is loaded; and
the recommendation information identifier is a session established between the browser and the recommendation server when the identifier loads the recommendation information.

5. The method according to claim 3, wherein the step of, in accordance with webpage state information about the current webpage, requesting recommendation information from a recommendation server corresponding to the browser, comprises:
when the current webpage is a specified webpage, using the webpage state information at least including the web address information of the current webpage to request the recommendation information from the recommendation server corresponding to the browser, wherein the server is used to search for the recommendation information corresponding to the web address information of the current webpage in accordance with the request;
or,
when the current webpage is loaded, using the webpage state information at least including the title information to request the recommendation information from the recommendation server corresponding to the browser, wherein the server is used to search for the recommendation information corresponding to the title information in accordance with the request;
or,
when the current webpage is the search result webpage of the search engine, using the webpage state information at least including the refer information of the current webpage to request the recommendation information from the recommendation server corresponding to the browser, wherein the server is used to perform a URL structure analysis by the refer information of the current webpage in accordance with the request, to extract search keyword information from the URL of the current webpage, to decode the search keyword information in accordance with a predefined webpage encoding rule to obtain the search keywords, and to search for the recommendation information corresponding to the search keywords.

6. The method according to claim 1, wherein the recommendation information comprises item data and display attribute data;
the step of loading the recommendation information requested from the recommendation server in a browser window of the current webpage at the browser side comprises:
generating an exhibition window in the browser window of the current webpage at the browser side in accordance with the display attribute data;
receiving the item data sent from the recommendation server; and
displaying the item data in the exhibition window.

7. The method according to claim 6, wherein the browser side has a recommendation information identifier corresponding to current recommendation information established at the recommendation server side;
the step of receiving the item data sent from the recommendation server comprises:
receiving the item data sent from the recommendation server with respect to the exhibition window and the recommendation information identifier corresponding to the current recommendation information.

8. The method according to claim 6, wherein the item data comprises at least one of:
text information, image information, audio information, video information and Flash information.

9. The method according to claim 1, wherein each webpage window at the browser side stores the corresponding recommendation information.

10. The method according to claim 1, wherein the method further comprises:
when the recommendation information is triggered, initiating a search request on the search engine by the recommendation information; and
loading a search result obtained by using the recommendation information to search in accordance with the search request through the search engine.

11. A method for detecting a web address, comprising:
at a web address security assembly side, monitoring that a browser in a computer system where a web address security assembly is located initiates a loading request of a current webpage;
determining whether the loading request conforms to a preset condition, and if yes, generating a recommendation information loading identifier;
sending the recommendation information loading identifier to the browser, wherein the browser is used to request the recommendation information from its corresponding recommendation server in accordance with webpage state information about the current webpage and load the recommendation information requested from the recommendation server in a browser window of the current webpage at the browser side.

12. The method according to claim 11, wherein the preset condition comprises:
the current webpage corresponding to the loading request is at least one of a webpage corresponding to a search result item in a search result webpage of previous search engine and a specified webpage.

13. The method according to claim 11, wherein before the step of determining whether the loading request conforms to a preset condition, the method further comprises:
extracting web address information of the current webpage from the loading request; and
performing security verification on the current webpage by using the web address information and determining the current webpage to be a safe webpage.

14.-26. (canceled)

27. A first computing device for loading recommendation information, comprising:
a first processor, configured to:
initiate a loading request of a current webpage at a browser side;
receive a recommendation information loading identifier sent with respect to the loading request from a web address security assembly in a computer system where the browser is located, wherein the recommendation information loading identifier is a recommendation information loading identifier generated when the web address security assembly determines that the loading request conforms to the preset condition;
in accordance with webpage state information about the current webpage, request recommendation information from a recommendation server corresponding to the browser; and
load the recommendation information requested from the recommendation server in a browser window of the current webpage at the browser side.

28.-34. (canceled)

35. The method according to claim 1, wherein the loading request includes a current webpage URL;
the web address security assembly is used to perform a structural analysis on the current webpage URL, extract search keyword information in the URL, and decode the search keyword information in accordance with a predefined webpage encoding rule; and
when successfully decoded, the current webpage is determined to be a webpage corresponding to the search result item in the search result webpage of search engine.

36. The method according to claim 1, wherein the method further comprises:
sending extended information which records setting parameters when previously loading other recommendation information to the recommendation server, wherein the recommendation server is used to make statistics on user behavior information by the extended information and in accordance with the user behavior information, return corresponding recommendation information to the browser side requesting the recommendation information.

37. The first computing device according to claim 27, wherein the preset condition comprises:
the current webpage corresponding to the loading request is at least one of a webpage corresponding to a search result item in a search result webpage of search engine, a specified webpage, and a verified safe webpage.

38. The first computing device according to claim 27, wherein the webpage state information comprises at least one of:
refer information of the current webpage, search keyword information in the refer information of the current webpage, web address information of the current webpage, title information, identification information of computer hardware and extended information, wherein
the refer information of the current webpage is information which records a URL corresponding to a search result webpage obtained by submitting search keywords in the search engine;
the web address information of the current webpage is information which records a URL of the current webpage requested to load;
the title information is information which records a title corresponding to the current webpage requested to load;
the identification information of computer hardware is information which identifies computer hardware where the browser is located; and
the extended information includes information which records setting parameters when other recommendation information is previously loaded.

39. The first computing device according to claim 38, wherein in accordance with webpage state information about the current webpage, request recommendation information from a recommendation server corresponding to the browser, comprises:
when the current webpage is a specified webpage, use the webpage state information at least including the web address information of the current webpage to request the recommendation information from the recommendation server corresponding to the browser, wherein the server is used to search for the recommendation information corresponding to the web address information of the current webpage in accordance with the request;
or,
when the current webpage is loaded, use the webpage state information at least including the title information to request the recommendation information from the recommendation server corresponding to the browser, wherein the server is used to search for the recommendation information corresponding to the title information in accordance with the request;
or,
when the current webpage is the search result webpage of the search engine, use the webpage state information at least including the refer information of the current webpage to request the recommendation information from the recommendation server corresponding to the browser, wherein the server is used to perform a URL structure analysis by the refer information of the current webpage in accordance with the request, to extract search keyword information from the URL of the current webpage, to decode the search keyword information in accordance with a predefined webpage encoding rule to obtain the search keywords, and to search for the recommendation information corresponding to the search keywords.

40. The first computing device according to claim 27, wherein the recommendation information comprises item data and display attribute data;
load the recommendation information requested from the recommendation server in a browser window of the current webpage at the browser side comprises:
generate an exhibition window in the browser window of the current webpage at the browser side in accordance with the display attribute data;
receive the item data sent from the recommendation server; and
display the item data in the exhibition window.
